(19) United States
(12) Patent Application Publication
(10) Pub. No.: US 2026/0311177 A1
(43) Pub. Date: Oct. 8, 2026

(54) INFORMATION PROCESSING SYSTEM, INFORMATION PROCESSING METHOD, AND NODE DEVICE

(71) Applicant: YENPOINT INC., Sendai-shi (JP)

(72) Inventor: Kenichiro SATO, Sendai-shi (JP)

(73) Assignee: YENPOINT INC., Sendai-shi (JP)

(21) Appl. No.: 19/461,994

(22) Filed: Jan. 28, 2026

Related U.S. Application Data
(63) Continuation of application No. PCT/JP2023/030831, filed on Aug. 26, 2023.

(51) Int. Cl. G06Q 20/40; G06Q 20/06; G06Q 20/36

(52) U.S. Cl. CPC G06Q 20/401; G06Q 20/065; G06Q 20/36; G06Q 2220/00

(57) ABSTRACT

An information processing system for recording includes: a first node device including a first wallet, the first node device including: a generator configured to generate new transaction information that is transaction information representing transfer of the token from the first wallet to a second wallet; and a first transmitter configured to transmit, to a second node device including the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history; and the second node device, including: a receiver configured to receive the new transaction information and the transaction history information.

### CROSS-REFERENCE TO RELATED APPLICATION

This application is a continuation application of International Application No. PCT/JP2023/30831, filed on Aug. 26, 2023 and designated the U.S., the entire contents of which are incorporated herein by reference.

### FIELD

The present disclosure relates to an information processing system, an information processing method, and a node device.

### BACKGROUND

There is known an information processing system in which a plurality of node devices each having a plurality of wallets communicate according to a peer-to-peer scheme, and transaction information representing transfer of a token associated with a coin between two wallets among the plurality of wallets is recorded in a distributed ledger constituted by a blockchain.

When transaction information is recorded in the distributed ledger, it is verified that a transfer of the coin represented by the transaction information is a valid transfer of the coin issued by a true issuer; however, it is not verified that a transfer of the token represented by the transaction information is a valid transfer of the token issued by the true issuer (in other words, validity of the token transfer is not verified).

Accordingly, for example, an information processing system described in Japanese Patent Publication No. 2022-88560 A includes a management device that verifies validity of a token transfer.

### SUMMARY

However, the management device cannot verify validity of a token transfer unless it extracts transaction information related to a token from all transaction information recorded in the distributed ledger.

The number of transaction information pieces recorded in the distributed ledger is considerably larger than the number of transaction information pieces related to a token. Accordingly, the load for extracting transaction information related to a token from all transaction information recorded in the distributed ledger is excessive. Thus, in the information processing system described above, there is a problem that the load for verifying validity of a token transfer is excessive. This problem may similarly occur even when a node device, instead of a management device, verifies validity of a token transfer.

One object of the present disclosure is to reduce the load for verifying validity of a token transfer.

In one aspect, an information processing system records, in a distributed ledger constituted by a blockchain, transaction information representing transfer of a token associated with a coin between two wallets among a plurality of wallets by communication among a plurality of node devices each having a plurality of wallets according to a peer-to-peer scheme.

A first node device having a first wallet includes a generation unit and a transmission unit. The generation unit generates new transaction information that is transaction information representing transfer of the token from the first wallet to a second wallet. The transmission unit transmits, to a second node device having the second wallet, the generated new transaction information and transaction history information including a group of transaction information pieces corresponding to a history of transfers of the token from issuance of the token to a transfer immediately prior to a transfer represented by the new transaction information, the transaction history information including the group of transaction information pieces in association with an order of transfers in the history.

The second node device includes a receiving unit and a verification unit. The receiving unit receives the new transaction information and the transaction history information. Based on the received new transaction information and the received transaction history information, the verification unit executes token transfer verification to verify that the transfer of the token to the second wallet is a valid transfer of the token issued by a true issuer.

In another aspect, an information processing method records, in a distributed ledger constituted by a blockchain, transaction information representing transfer of a token associated with a coin between two wallets among a plurality of wallets by communication among a plurality of node devices each having a plurality of wallets according to a peer-to-peer scheme.

The information processing method includes:

generating, by a first node device having a first wallet, new transaction information that is transaction information representing transfer of the token from the first wallet to a second wallet;

transmitting, by the first node device to a second node device having the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history;

receiving, by the second node device, the new transaction information and the transaction history information; and

executing, by the second node device, token transfer verification, based on the received new transaction information and the received transaction history information, to verify that the transfer of the token to the second wallet is a valid transfer of the token issued by a true issuer.

In another aspect, a node device has a first wallet in an information processing system that records, in a distributed ledger constituted by a blockchain, transaction information representing transfer of a token associated with a coin between two wallets among a plurality of wallets by communication among a plurality of node devices each having a plurality of wallets according to a peer-to-peer scheme.

The node device includes a generation unit and a transmission unit. The generation unit generates new transaction information that is transaction information representing transfer of the token from the first wallet to a second wallet. The transmission unit transmits, to a second node device having the second wallet, the generated new transaction information and transaction history information including a group of transaction information pieces corresponding to a history of transfers of the token from issuance of the token to a transfer immediately prior to a transfer represented by the new transaction information, the transaction history information including the group of transaction information pieces in association with an order of transfers in the history.

In another aspect, a node device has a second wallet in an information processing system that records, in a distributed ledger constituted by a blockchain, transaction information representing transfer of a token associated with a coin between two wallets among a plurality of wallets by communication among a plurality of node devices each having a plurality of wallets according to a peer-to-peer scheme.

The node device includes a receiving unit and a verification unit. The receiving unit receives, from a first node device having a first wallet, new transaction information that is transaction information representing transfer of the token from the first wallet to the second wallet, and transaction history information including a group of transaction information pieces corresponding to a history of transfers of the token from issuance of the token to a transfer immediately prior to a transfer represented by the new transaction information, the transaction history information including the group of transaction information pieces in association with an order of transfers in the history. Based on the received new transaction information and the received transaction history information, the verification unit executes token transfer verification to verify that the transfer of the token to the second wallet is a valid transfer of the token issued by a true issuer.

The load for verifying validity of a token transfer can be reduced.

### BRIEF DESCRIPTION OF DRAWING

FIG. 1 is a block diagram illustrating a configuration of an information processing system according to a first embodiment.

FIG. 2 is a block diagram illustrating a configuration of a node device according to the first embodiment.

FIG. 3 is a block diagram illustrating functions of the node device according to the first embodiment.

FIG. 4 is a block diagram illustrating a part of functions of a granting node device and a part of functions of a receiving node device according to the first embodiment.

FIG. 5 is a sequence diagram illustrating an example of an operation of the information processing system according to the first embodiment.

FIG. 6 is a flowchart illustrating granting-time processing executed by the granting node device according to the first embodiment.

FIG. 7 is a flowchart illustrating receiving-time processing executed by the receiving node device according to the first embodiment.

FIG. 8 is a flowchart illustrating token transfer verification executed by the receiving node device according to the first embodiment.

FIG. 9 is a flowchart illustrating record verification executed by the receiving node device according to the first embodiment.

FIG. 10 is a flowchart illustrating continuity verification executed by the receiving node device according to the first embodiment.

FIG. 11 is a flowchart illustrating issuance verification executed by the receiving node device according to the first embodiment.

FIG. 12 is a flowchart illustrating rule verification executed by the receiving node device according to the first embodiment.

FIG. 13 is a block diagram illustrating functions of a node device according to a first modification of the first embodiment.

FIG. 14 is a flowchart illustrating receiving-time processing executed by a receiving node device according to the first modification of the first embodiment.

FIG. 15 is a flowchart illustrating issuance verification executed by the receiving node device according to the first modification of the first embodiment.

FIG. 16 is a flowchart illustrating rule verification executed by the receiving node device according to the first modification of the first embodiment.

FIG. 17 is a block diagram illustrating functions of a node device according to a second modification of the first embodiment.

FIG. 18 is a flowchart illustrating receiving-time processing executed by a receiving node device according to the second modification of the first embodiment.

FIG. 19 is a flowchart illustrating token transfer verification executed by the receiving node device according to the second modification of the first embodiment.

FIG. 20 is a flowchart illustrating verified determination executed by the receiving node device according to the second modification of the first embodiment.

FIG. 21 is a flowchart illustrating record verification executed by the receiving node device according to the second modification of the first embodiment.

FIG. 22 is a flowchart illustrating continuity verification executed by the receiving node device according to the second modification of the first embodiment.

FIG. 23 is a flowchart illustrating issuance verification executed by the receiving node device according to the second modification of the first embodiment.

FIG. 24 is a flowchart illustrating rule verification executed by the receiving node device according to the second modification of the first embodiment.

FIG. 25 is a sequence diagram illustrating an example of an operation of an information processing system according to a second embodiment.

FIG. 26 is a flowchart illustrating receiving-time processing executed by the receiving node device according to the second embodiment.

### DESCRIPTION OF EMBODIMENTS

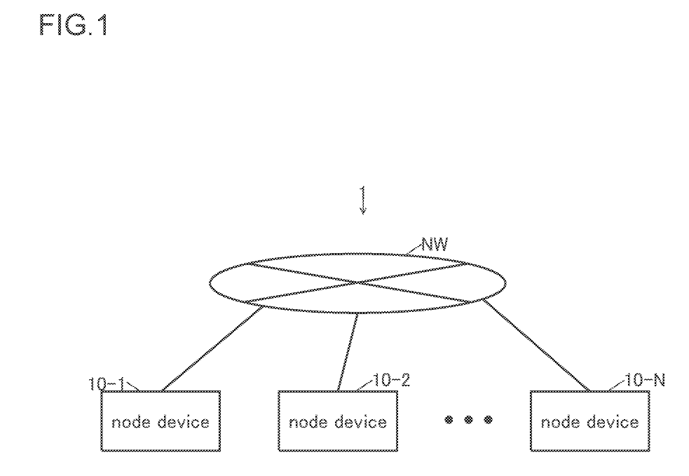

Embodiments relating to an information processing system, an information processing method, and a node device according to the present disclosure will be described below with reference to FIGS. 1 to 26.

### First Embodiment

### Overview

An information processing system according to the first embodiment records, in a distributed ledger constituted by a blockchain, transaction information representing transfer of a token associated with a coin between two wallets among a plurality of wallets by communication among a plurality of node devices each having a plurality of wallets according to a peer-to-peer scheme.

A first node device having a first wallet includes a generation unit and a transmission unit. The generation unit generates new transaction information that is transaction information representing transfer of the token from the first wallet to a second wallet. The transmission unit transmits, to a second node device having the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history.

A second node device having a second wallet includes a receiving unit and a verification unit. The receiving unit receives the new transaction information and the transaction history information. Based on the received new transaction information and the received transaction history information, the verification unit executes token transfer verification to verify that the transfer of the token to the second wallet is a valid transfer of the token issued by a true issuer.

According to this configuration, new transaction information and transaction history information are transmitted from the first node device to the second node device, and the second node device verifies that the token transfer is a valid transfer of a token issued by a true issuer (in other words, validity of the token transfer). Thus, validity of the token transfer can be verified without extracting transaction information related to a token from all transaction information recorded in the distributed ledger. Accordingly, the load for verifying validity of the token transfer can be reduced.

Further, the second node device can verify validity of the token transfer in response to receiving the new transaction information and the transaction history information from the first node device. Accordingly, the second node device can quickly verify validity of the token transfer. Next, the information processing system according to the first embodiment will be described in more detail.

### Configuration

As illustrated in FIG. 1, an information processing system 1 includes a plurality (in this example, N) of node devices 10-1, 10-2, ..., 10-N. N represents an integer of 2 or more. The number of node devices 10-n (n represents an integer of 1 to N) constituting the information processing system 1 may change over time.

The N node devices 10-1, 10-2, ..., 10-N are connected via a communication line NW so as to be capable of mutual communication. The communication line NW may include a wireless transmission path. In this example, each node device 10-n has at least one wallet. At least one of the N node devices 10-1, 10-2, ..., 10-N may have no wallet.

A wallet represents a function of storing crypto-assets. A wallet may also be referred to as a "wallet." In this example, crypto-assets include coins and tokens. In this example, a coin is Bitcoin. The coin may be a virtual currency different from Bitcoin (for example, BTC, Litecoin, Bitcoin Cash, Bitcoin SV, Dash, Dogecoin, or Zcash).

In this example, a token is a crypto-asset different from a coin. For example, a token may be a virtual currency different from a coin. Further, a token may be issued on an existing blockchain and used to digitally represent or manage a specific right, attribute, value, data, function, or the like. A token may be a right to use a specific service, a right to own a specific item, a right to purchase a specific item, or the like.

For example, a token may be a token called a Layer 0 token, a Layer 1 token, or a Layer 2 token. For example, a token may be an NFT (Non-Fungible Token) or an FT (Fungible Token).

The information processing system 1 records transaction information in a distributed ledger constituted by a blockchain by communication among the N node devices 10-1, 10-2, ..., 10-N according to a peer-to-peer (Peer to Peer) scheme. The transaction information represents transfer (in other words, a transaction) of a token associated with a coin between two wallets among the plurality of wallets. The transaction information may simply be referred to as a "transaction." The distributed ledger is stored in a distributed manner among the N node devices 10-1, 10-2, ..., 10-N.

In this example, the information processing system 1 uses a blockchain in accordance with a UTXO (Unspent Transaction Output) scheme. The information processing system 1 may use a blockchain in accordance with a token-based scheme, an account scheme (in other words, an account-based scheme), or a hybrid scheme combining a UTXO scheme and an account scheme. Further, the information processing system 1 may use DLT (Distributed Ledger Technology). In this case, the information processing system 1 may use, for example, a directed acyclic graph (Directed Acyclic Graph).

Each node device 10-n is an information processing apparatus or a computer. For example, the computer may be a server computer, a desktop computer, a laptop computer, a tablet computer, or a smartphone. Further, the computer may be at least a part of a payment terminal, a stationary game console, a portable game console, a television receiver, or the like. Each node device 10-n may be constituted by a plurality of devices connected so as to be capable of mutual communication.

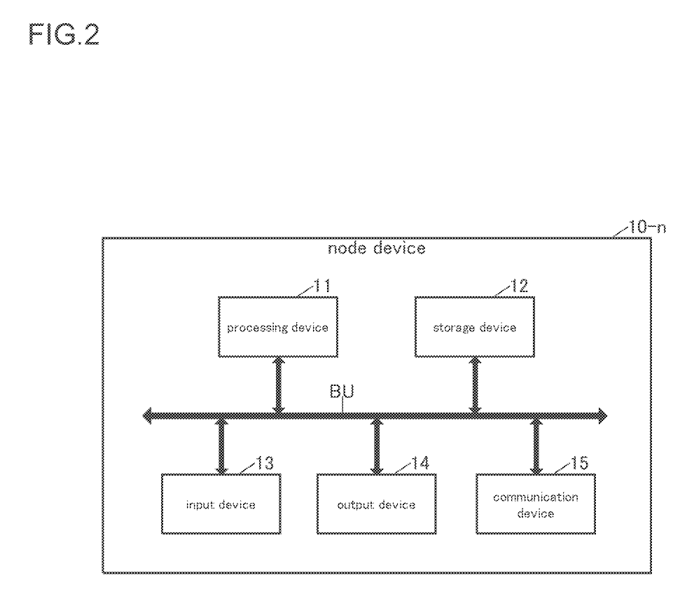

As illustrated in FIG. 2, each node device 10-n includes a processing device 11, a storage device 12, an input device 13, an output device 14, and a communication device 15, which are connected to each other via a bus BU. The processing device 11 controls the storage device 12, the input device 13, the output device 14, and the communication device 15 by executing a program stored in the storage device 12. Thereby, each node device 10-n realizes functions described below.

In this example, the processing device 11 is a CPU (Central Processing Unit). The processing device 11 may include, instead of or in addition to a CPU, an MPU (Micro Processing Unit), a GPU (Graphics Processing Unit), a DSP (Digital Signal Processor), an FPGA (Field-Programmable Gate Array), an ASIC (Application-Specific Integrated Circuit), or a TPU (Tensor Processing Unit).

In this example, the storage device 12 includes a volatile memory and a non-volatile memory. For example, the storage device 12 includes at least one of RAM (Random Access Memory), ROM (Read Only Memory), a semiconductor memory, an organic memory, an HDD (Hard Disk Drive), and an SSD (Solid State Drive).

The input device 13 inputs information from outside the node device 10-n. In this example, the input device 13 includes a keyboard and a mouse. The input device 13 may include a microphone. The output device 14 outputs information to outside the node device 10-n. In this example, the output device 14 includes a display. The output device 14 may include a speaker. The node device 10-n may include a touch-panel display that constitutes both the input device 13 and the output device 14.

The communication device 15 communicates with an external device of the node device 10-n. In this example, the communication device 15 includes a card-type or on-board network adapter or network interface.

### Functions

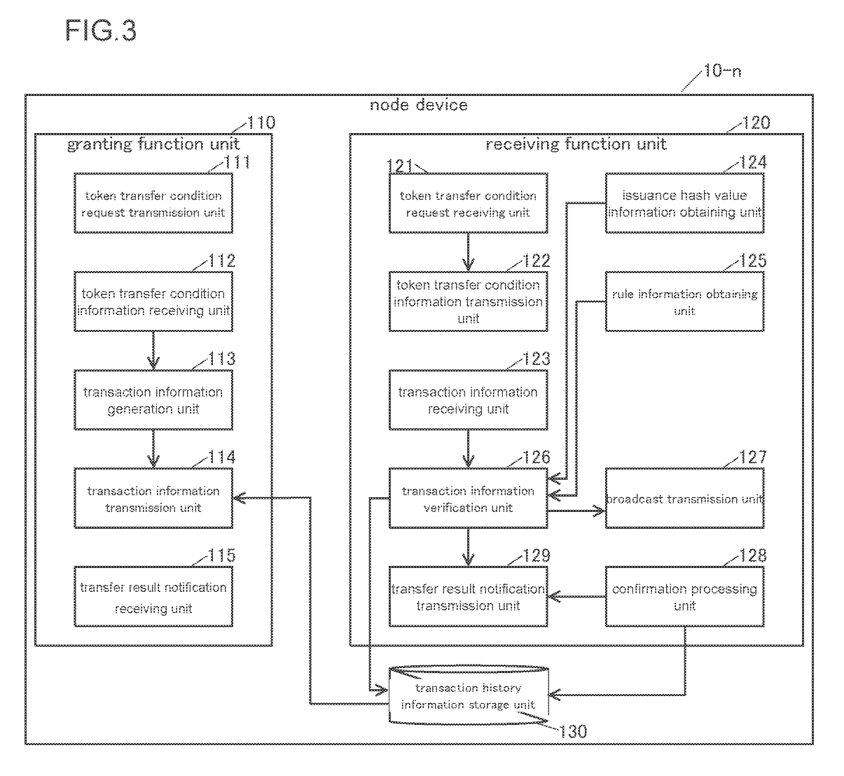

As illustrated in FIG. 3, functions of each node device 10-n include a granting function unit 110, a receiving function unit 120, and a transaction history information storage unit 130. At least one of the N node devices 10-1, 10-2, ..., 10-N may include neither the granting function unit 110 nor the receiving function unit 120.

The granting function unit 110 includes a token transfer condition request transmission unit 111, a token transfer condition information receiving unit 112, a transaction information generation unit 113, a transaction information transmission unit 114, and a transfer result notification receiving unit 115.

The receiving function unit 120 includes a token transfer condition request receiving unit 121, a token transfer condition information transmission unit 122, a transaction information receiving unit 123, an issuance hash value information obtaining unit 124, a rule information obtaining unit 125, a transaction information verification unit 126, a broadcast transmission unit 127, a confirmation processing unit 128, and a transfer result notification transmission unit 129.

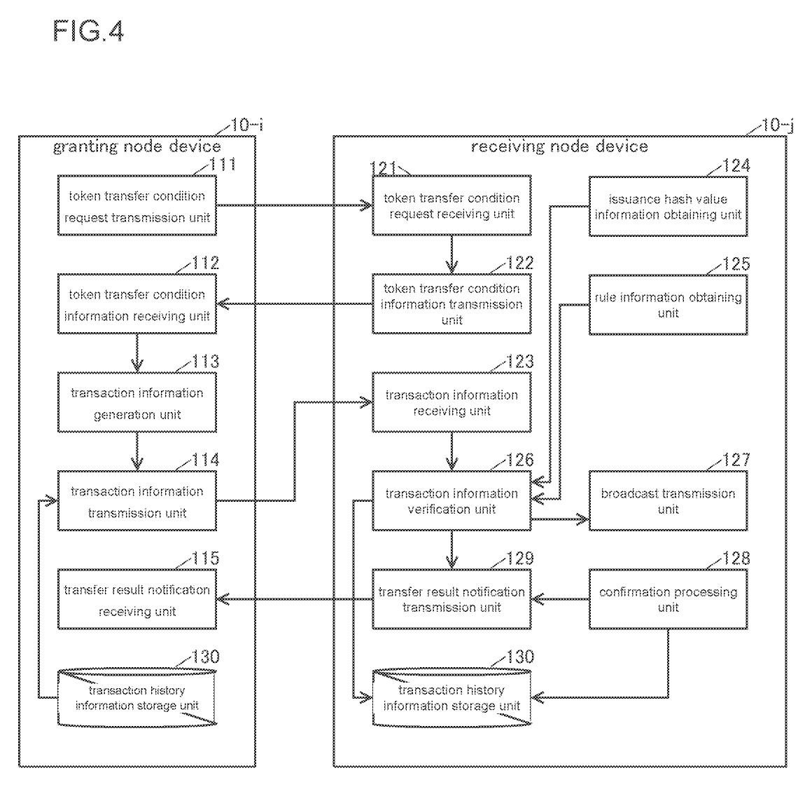

Hereinafter, focusing on (i) a node device that grants a token (in other words, a node device that is a transfer source of the token; hereinafter, a granting node device) 10-i (i represents an integer of 1 to N) and (ii) a node device that receives the token (in other words, a node device that is a transfer destination of the token; hereinafter, a receiving node device) 10-j (j represents an integer of 1 to N other than i), functions of each unit of the node device 10-n will be further described with reference to FIG. 4.

In this example, the granting node device 10-i corresponds to the first node device, and the wallet of the granting node device 10-i corresponds to the first wallet. Further, in this example, the receiving node device 10-j corresponds to the second node device, and the wallet of the receiving node device 10-j corresponds to the second wallet.

The token transfer condition request transmission unit 111 of the granting node device 10-i transmits a token transfer condition request to the receiving node device 10-j. The token transfer condition request is information indicating a request for token transfer condition information representing conditions relating to a token transfer.

The token transfer condition request receiving unit 121 of the receiving node device 10-j receives the token transfer condition request from the granting node device 10-i. When the token transfer condition request receiving unit 121 receives the token transfer condition request, the token transfer condition information transmission unit 122 of the receiving node device 10-j transmits token transfer condition information to the granting node device 10-i that is the transmission source of the token transfer condition request.

For example, the token transfer condition information represents token transfer conditions that are conditions required for a token to be transferred. In this example, token transfer conditions include information identifying a token rule set of a token to be transferred, information identifying a type of the token to be transferred, information representing an amount of tokens to be transferred, and information representing a period during which a token transfer is accepted.

A token rule set is a set of rules for issuing a token and operating the token. The token rule set is determined by a token issuer. For example, the token rule set defines an issuance amount of a token, an issuer of a token, an issuance method of a token, an issuance price of a token, a usage method of a token, a storage method of a token, or a transfer method of a token.

For example, the token rule set may be determined using a token protocol such as Ordinals, BRC-20, BSV-20, 1-sat Ordinals, STAS Token, Run on Bitcoin, Bitcoin Computer Token, Sensible, Elas Token, Simple Fabrik Protocol for Tokens (SFP), CRC-20, Simple Ledger Protocol (SLP), ColorCoin, Counterparty, Omni, or Open Asset Protocol.

The token transfer condition information receiving unit 112 of the granting node device 10-i receives token transfer condition information from the receiving node device 10-j that is the transmission destination of the token transfer condition request.

When the token transfer condition information receiving unit 112 receives the token transfer condition information, the transaction information generation unit 113 of the granting node device 10-i generates new transaction information that satisfies the token transfer conditions represented by the received token transfer condition information.

The new transaction information is transaction information representing transfer of a coin and a token from the first wallet to the second wallet. In this example, the token transfer is performed in association with the coin transfer.

In this example, transaction information represents a transaction (in other words, transfer) of a coin and a token. In this example, transaction information includes at least one input information item and at least one output information item.

Input information identifies output information that is a source coin to be transferred (in other words, output information in an immediately preceding transfer) and includes information proving a right to use the coin. In this example, the input information includes previous-transfer information, output identification information, and restriction release information.

The previous-transfer information included in the input information is information identifying immediately preceding transfer transaction information, which is transaction information representing an immediately preceding transfer of a transfer represented by transaction information including the input information. In this example, the previous-transfer information is previous-transfer hash value information generated by inputting the immediately preceding transfer transaction information to a hash function.

In this example, the hash function is SHA-256 (Secure Hash Algorithm 256-bit). The hash function may be a hash function other than SHA-256 (for example, SHA-3).

In this example, the previous-transfer hash value information is hash value information (in other words, double hash value information) generated by further inputting, to the hash function, hash value information generated by inputting the immediately preceding transfer transaction information to the hash function. The previous-transfer hash value information may be hash value information (in other words, single hash value information) generated by inputting the immediately preceding transfer transaction information to the hash function.

The output identification information included in the input information is information identifying output information included in immediately preceding transfer transaction information identified by the previous-transfer information included in the input information. The restriction release information included in the input information is information proving a right to use a source coin of transfer represented by output information specified by the input information.

Output information represents an amount of coins to be transferred and includes information restricting use of the coin such that only a wallet that is a transfer destination of the coin can prove a right to use the coin. In this example, the output information includes transfer coin amount information and use restriction information.

The transfer coin amount information included in the output information is information representing an amount of coins to be transferred. The use restriction information included in the output information is information restricting use of the coin such that only a wallet that is a transfer destination of the coin can prove a right to use the coin.

Further, the transaction information includes token transfer information representing transfer of a token associated with a coin. For example, the token transfer information may include information representing an amount of tokens to be transferred. The token transfer information may not include information representing the amount of tokens to be transferred. In this case, the amount of tokens to be transferred may be determined based on the transfer coin amount information. For example, the token transfer information may include information identifying a wallet that is a transfer destination of the token. When the token transfer information does not include information identifying a wallet that is a transfer destination of the token, the transfer destination of the token may match a transfer destination of the coin.

In this example, token transfer information is included in at least one of the restriction release information and the use restriction information. Token transfer information may be included in information other than the restriction release information and the use restriction information.

The transaction information transmission unit 114 of the granting node device 10-i transmits, to the receiving node device 10-j, new transaction information generated by the transaction information generation unit 113 and transaction history information stored in the transaction history information storage unit 130. In this example, the transaction information transmission unit 114 corresponds to the transmission unit.

The transaction history information transmitted together with the new transaction information representing transfer of a coin and a token includes a group of transaction information pieces (in other words, a plurality of transaction information pieces) corresponding to a history of transfers of the token from issuance of the token to a transfer immediately prior to the transfer represented by the new transaction information, the transaction history information including the group of transaction information pieces in association with an order of transfers in the history.

In this example, in the transaction history information, the group of transaction information pieces corresponding to the history of transfers of the token is arranged in accordance with the order of transfers in the history. The group of transaction information pieces may be arranged in an order reverse to the order of transfers in the history. Further, in the transaction history information, each of the plurality of transaction information pieces corresponding to the history of transfers of the token may be associated with information specifying the order of transfers of the transaction information piece in the history.

The transaction information receiving unit 123 of the receiving node device 10-j receives, from the granting node device 10-i, the new transaction information and the transaction history information. In this example, the transaction information receiving unit 123 corresponds to the receiving unit.

The issuance hash value information obtaining unit 124 of the receiving node device 10-j obtains issuance hash value information. In this example, the issuance hash value information obtaining unit 124 corresponds to the obtaining unit. The issuance hash value information is generated by inputting, to a hash function, transaction information representing issuance of the token. In this example, the issuance hash value information is double hash value information. The issuance hash value information may be single hash value information.

Transaction information representing issuance of the token may be referred to as a token genesis. In this example, the transaction information representing issuance of the token is generated by the token issuer. In this example, the issuance hash value information obtaining unit 124 obtains issuance hash value information from the token issuer. For example, the issuance hash value information obtaining unit 124 may obtain issuance hash value information by receiving issuance hash value information from an information processing device managed by the token issuer.

The rule information obtaining unit 125 of the receiving node device 10-j obtains rule information. In this example, the rule information obtaining unit 125 corresponds to the obtaining unit. The rule information represents rules to be complied with by token transfer information included in transaction information. In this example, the rule information represents a token rule set.

The rule information is generated by the token issuer. In this example, the rule information obtaining unit 125 obtains the rule information from the token issuer. For example, the rule information obtaining unit 125 may obtain the rule information by receiving the rule information from an information processing device managed by the token issuer.

Based on the new transaction information and the transaction history information received by the transaction information receiving unit 123, the transaction information verification unit 126 of the receiving node device 10-j executes token transfer verification to verify that transfer of a token from the first wallet to the second wallet is a valid transfer of a token issued by a true issuer. In this example, the transaction information verification unit 126 corresponds to the verification unit.

In this example, token transfer verification includes record verification, continuity verification, issuance verification, and rule verification. Record verification verifies that, among the group of transaction information pieces included in the transaction history information, transaction information representing a transfer immediately prior to the transfer represented by the new transaction information is recorded in the distributed ledger.

Continuity verification verifies, for each transaction information pair, of transaction information pairs, each transaction information pair consisting of two transaction information pieces representing two consecutive transfers among a plurality of transaction information pieces consisting of the new transaction information and the group of transaction information pieces included in the transaction history information, that hash value information generated by inputting, to the hash function, transaction information representing a preceding transfer matches previous-transfer hash value information (in this example, previous-transfer information) included in transaction information representing a subsequent transfer.

Issuance verification verifies that hash value information generated by inputting, to the hash function, transaction information that is among the group of transaction information pieces included in the transaction history information and represents issuance of the token matches issuance hash value information obtained by the issuance hash value information obtaining unit 124.

Rule verification verifies, for each of the plurality of transaction information pieces consisting of the new transaction information and the group of transaction information pieces included in the transaction history information, that token transfer information included in the transaction information piece complies with rules represented by rule information obtained by the rule information obtaining unit 125 (in this example, the token rule set).

When the token transfer verification by the transaction information verification unit 126 succeeds, the broadcast transmission unit 127 of the receiving node device 10-j transmits, by broadcast, the new transaction information received by the transaction information receiving unit 123 to node devices other than the receiving node device 10-j among the N node devices 10-1, 10-2, ..., 10-N.

On the other hand, when the token transfer verification by the transaction information verification unit 126 fails, the broadcast transmission unit 127 does not transmit the new transaction information received by the transaction information receiving unit 123. In this example, the broadcast transmission unit 127 corresponds to the transmission unit.

When the new transaction information is transmitted by the broadcast transmission unit 127, the confirmation processing unit 128 of the receiving node device 10-j transmits a confirmation request to node devices other than the receiving node device 10-j among the N node devices 10-1, 10-2, ..., 10-N. The confirmation request includes information identifying the new transaction information and indicates a request for a confirmation reply indicating whether the new transaction information is recorded in the distributed ledger.

In this example, the node devices verify that transfer of a coin represented by the new transaction information is a valid transfer of a coin issued by a true issuer, and record the new transaction information in the distributed ledger. In this example, the distributed ledger includes a plurality of blocks, each block including a plurality of transaction information pieces. Processing executed by the node devices to record new transaction information in the distributed ledger includes processing referred to as mining.

The confirmation processing unit 128 receives confirmation replies transmitted from the node devices in response to the confirmation request. A confirmation reply to the confirmation request is information indicating whether the new transaction information identified by the confirmation request is recorded in the distributed ledger.

The transfer result notification transmission unit 129 of the receiving node device 10-j transmits a transfer result notification to the granting node device 10-i. The transfer result notification represents a result of transfer of a coin and a token. In this example, the transfer result notification is a transfer approval notification or a transfer failure notification. The transfer approval notification indicates that transfer of a coin and a token has been approved. The transfer failure notification indicates that transfer of a coin and a token has not been approved (in other words, the transfer has failed).

When token transfer verification by the transaction information verification unit 126 succeeds and thereafter a confirmation reply indicating that the new transaction information is recorded in the distributed ledger is received by the confirmation processing unit 128, the transfer result notification transmission unit 129 transmits the transfer approval notification as the transfer result notification to the granting node device 10-i.

On the other hand, when token transfer verification by the transaction information verification unit 126 fails, the transfer result notification transmission unit 129 transmits the transfer failure notification as the transfer result notification to the granting node device 10-i.

The transfer result notification receiving unit 115 of the granting node device 10-i receives a transfer result notification from the receiving node device 10-j. When the transfer result notification is the transfer approval notification, the transfer result notification receiving unit 115 outputs transfer approval information indicating that transfer of a coin and a token has been approved.

On the other hand, when the transfer result notification is the transfer failure notification, the transfer result notification receiving unit 115 outputs transfer failure information indicating that transfer of a coin and a token has not been approved (in other words, the transfer has failed).

When token transfer verification by the transaction information verification unit 126 succeeds and thereafter a confirmation reply indicating that the new transaction information is recorded in the distributed ledger is received by the confirmation processing unit 128, the transaction history information storage unit 130 of the receiving node device 10-j updates the transaction history information by adding, to the transaction history information received by the transaction information receiving unit 123, the new transaction information, and stores the updated transaction history information together with the new transaction information.

### Operation

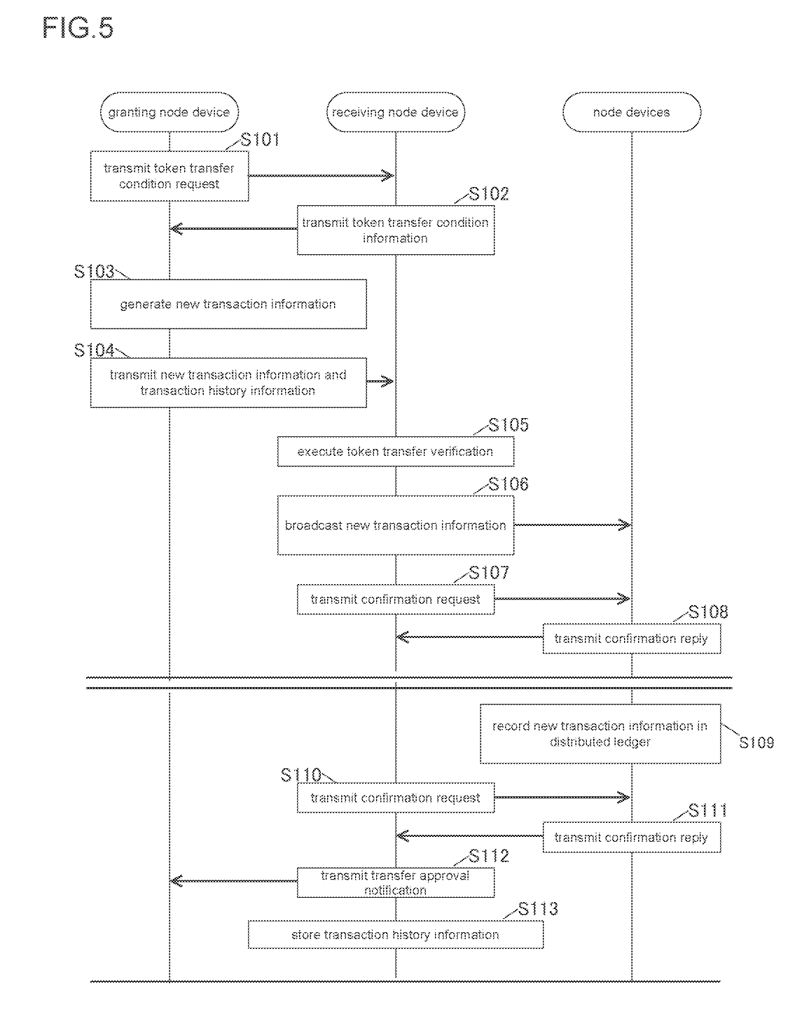

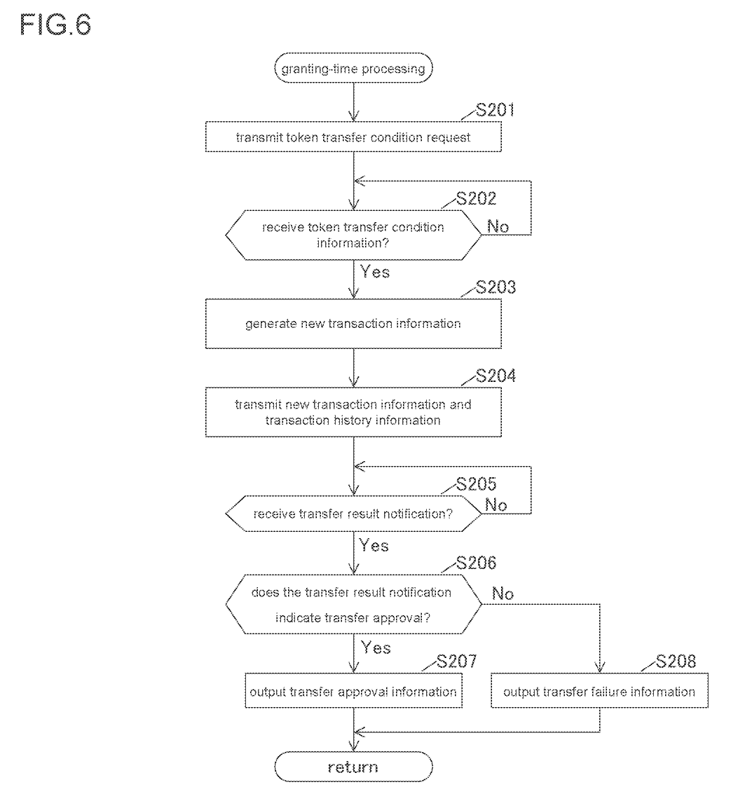

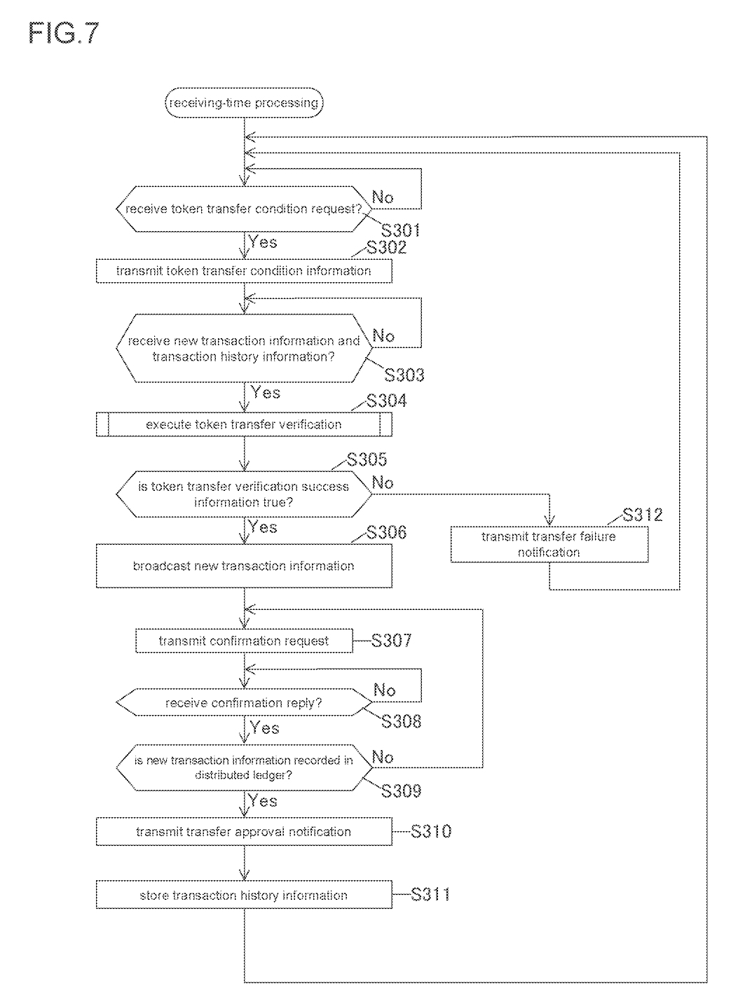

Next, an operation of the information processing system 1 will be described with reference to FIGS. 5 to 12. FIG. 5 is a sequence diagram illustrating an example of an operation of the information processing system 1. FIG. 6 is a flowchart illustrating an example of granting-time processing executed by the granting node device 10-i. FIG. 7 is a flowchart illustrating an example of receiving-time processing executed by the receiving node device 10-j.

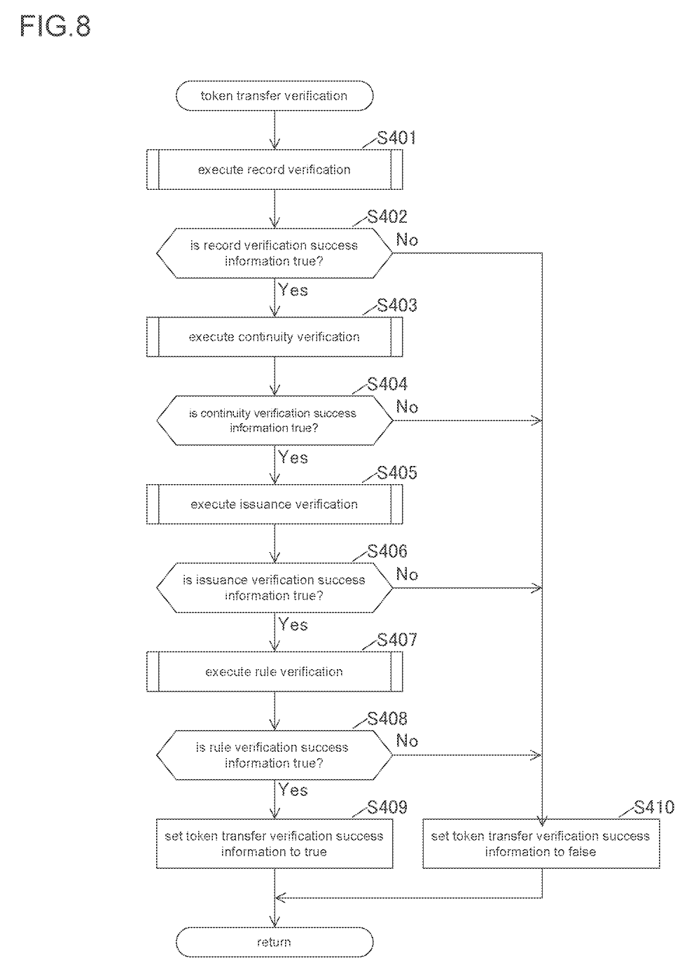

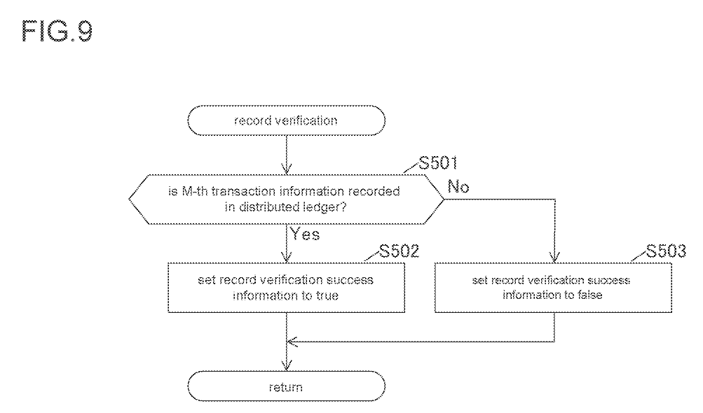

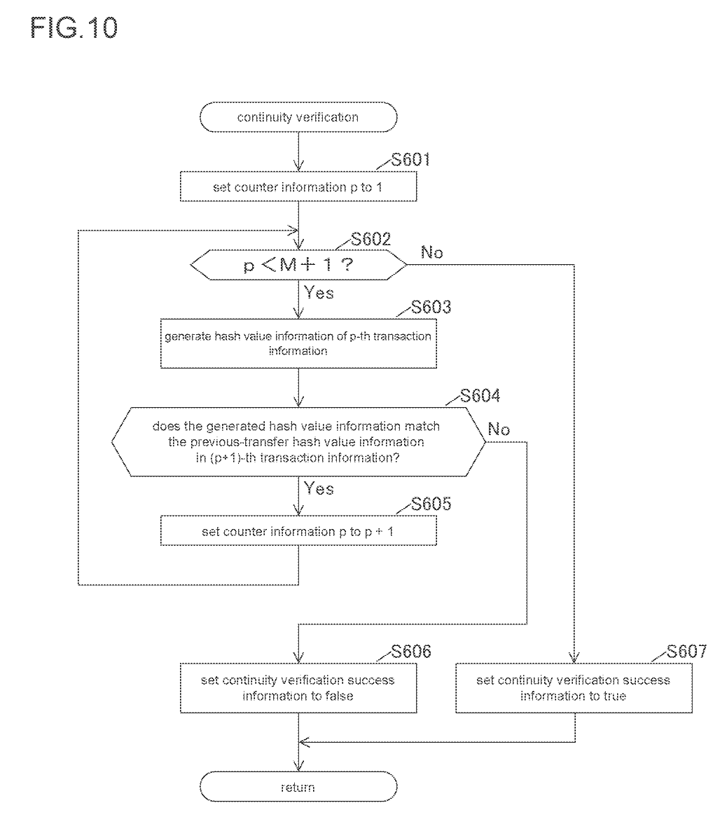

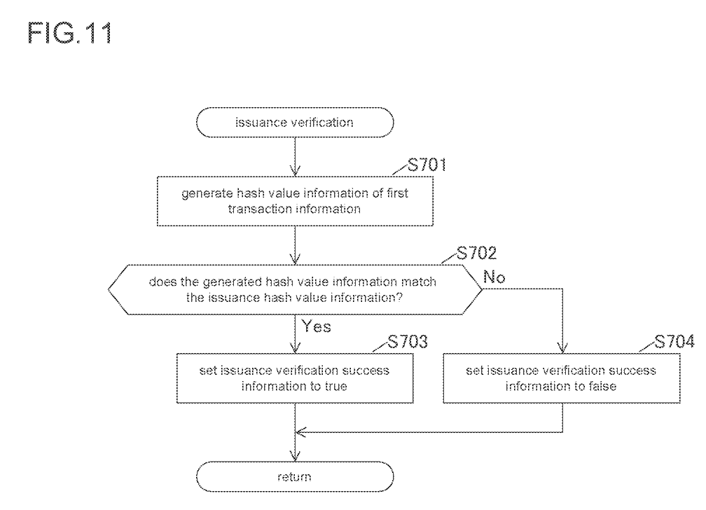

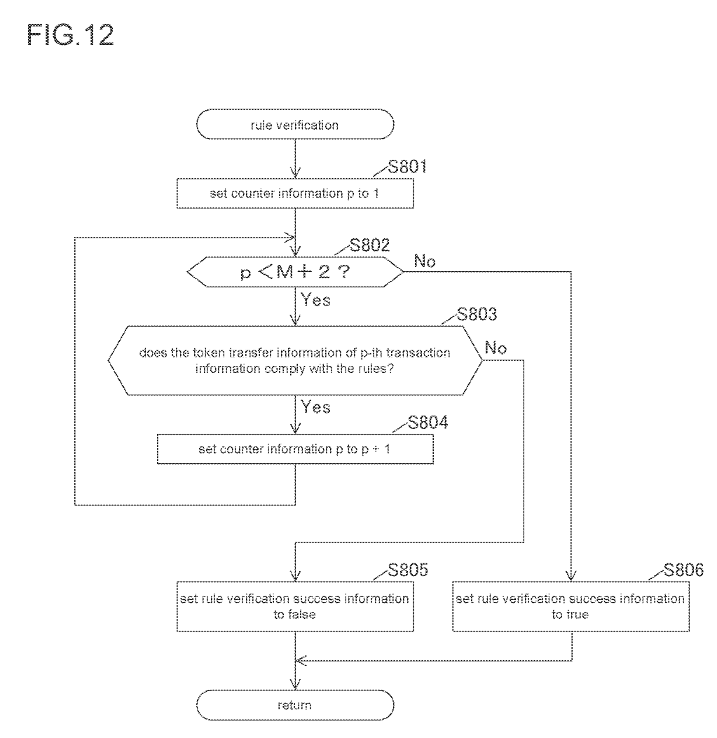

FIG. 8 is a flowchart illustrating an example of token transfer verification executed by the receiving node device 10-j. FIG. 9 is a flowchart illustrating an example of record verification executed by the receiving node device 10-j. FIG. 10 is a flowchart illustrating an example of continuity verification executed by the receiving node device 10-j. FIG. 11 is a flowchart illustrating an example of issuance verification executed by the receiving node device 10-j. FIG. 12 is a flowchart illustrating an example of rule verification executed by the receiving node device 10-j.

In this example, the granting node device 10-i executes granting-time processing illustrated in FIG. 6 in order to grant a coin and a token. First, the granting node device 10-i transmits a token transfer condition request to the receiving node device 10-j (step S101 in FIG. 5 and step S201 in FIG. 6). Next, the granting node device 10-i waits until token transfer condition information is received from the receiving node device 10-j (the determination of "No" is repeated in step S202 in FIG. 6).

In this example, the receiving node device 10-j executes receiving-time processing illustrated in FIG. 7 in order to receive a coin and a token. The receiving node device 10-j waits until a token transfer condition request is received (the determination of "No" is repeated in step S301 in FIG. 7).

Thereafter, the receiving node device 10-j receives a token transfer condition request from the granting node device 10-i (step S101 in FIG. 5). Accordingly, the receiving node device 10-j determines "Yes" in step S301 in FIG. 7 and transmits token transfer condition information to the granting node device 10-i (step S102 in FIG. 5 and step S302 in FIG. 7). Next, the receiving node device 10-j waits until new transaction information and transaction history information are received from the granting node device 10-i (the determination of "No" is repeated in step S303 in FIG. 7).

Accordingly, the granting node device 10-i receives token transfer condition information from the receiving node device 10-j (step S102 in FIG. 5). Therefore, the granting node device 10-i determines "Yes" in step S202 in FIG. 6 and generates new transaction information (step S103 in FIG. 5 and step S203 in FIG. 6).

Next, the granting node device 10-i transmits the generated new transaction information and the transaction history information stored in the transaction history information storage unit 130 to the receiving node device 10-j (step S104 in FIG. 5 and step S204 in FIG. 6). Next, the granting node device 10-i waits until a transfer result notification is received from the receiving node device 10-j (the determination of "No" is repeated in step S205 in FIG. 6).

Accordingly, the receiving node device 10-j receives new transaction information and transaction history information from the granting node device 10-i (step S104 in FIG. 5). Therefore, the receiving node device 10-j determines "Yes" in step S303 in FIG. 7 and executes token transfer verification (step S105 in FIG. 5 and step S304 in FIG. 7).

In order to execute token transfer verification, the receiving node device 10-j executes processing illustrated in FIG. 8. In the processing of FIG. 8, first, the receiving node device 10-j executes record verification (step S401 in FIG. 8). In order to execute record verification, the receiving node device 10-j executes processing illustrated in FIG. 9.

In the processing of FIG. 9, first, the receiving node device 10-j determines whether M-th transaction information is recorded (in other words, already recorded) in the distributed ledger (step S501 in FIG. 9). M represents the number of transaction information pieces included in the transaction history information, i.e., the number of transactions. In this example, an m-th transaction information piece is transaction information whose order from the beginning in the history of transfers of the token is m-th. m represents an integer of 1 to M+1. Accordingly, in this example, the first transaction information piece is transaction information representing issuance of the token. Further, in this example, the (M+1)-th transaction information piece is the new transaction information.

When holding the distributed ledger, the receiving node device 10-j makes the above determination based on the held distributed ledger. When not holding the distributed ledger, the receiving node device 10-j makes the above determination by communicating with the node devices.

When the M-th transaction information piece is recorded in the distributed ledger, the receiving node device 10-j determines "Yes" in step S501 in FIG. 9, sets record verification success information to a true value (step S502 in FIG. 9), and ends the processing of FIG. 9. The record verification success information is information indicating whether record verification has succeeded.

When the M-th transaction information piece is not recorded in the distributed ledger, the receiving node device 10-j determines "No" in step S501 in FIG. 9, sets record verification success information to a false value (step S503 in FIG. 9), and ends the processing of FIG. 9.

Next, the receiving node device 10-j determines whether record verification success information is set to a true value (step S402 in FIG. 8). When record verification success information is set to a true value, the receiving node device 10-j determines "Yes" in step S402 in FIG. 8 and executes continuity verification (step S403 in FIG. 8). In order to execute continuity verification, the receiving node device 10-j executes processing illustrated in FIG. 10.

In the processing of FIG. 10, first, the receiving node device 10-j sets counter information p to 1 (step S601 in FIG. 10). The counter information p represents an integer. Next, the receiving node device 10-j determines whether the counter information p is smaller than M+1, which is a value obtained by adding 1 to the number of transactions M (step S602 in FIG. 10).

At this point, the counter information p is smaller than M+1. Accordingly, the receiving node device 10-j determines "Yes" in step S602 in FIG. 10 and generates hash value information (in this example, double hash value information) by inputting p-th transaction information to the hash function (step S603 in FIG. 10).

Next, the receiving node device 10-j determines whether the hash value information generated in step S603 in FIG. 10 matches previous-transfer hash value information (in this example, previous-transfer information) included in (p+1)-th transaction information (step S604 in FIG. 10).

When the generated hash value information matches the previous-transfer hash value information included in the (p+1)-th transaction information, the receiving node device 10-j determines "Yes" in step S604 in FIG. 10, sets the counter information p to p+1 (in other words, increments the counter information p by 1) (step S605 in FIG. 10), returns to step S602 in FIG. 10, and repeatedly executes steps S602 to S605.

Thereafter, when the receiving node device 10-j proceeds to step S602 in FIG. 10 with the counter information p equal to M+1, the receiving node device 10-j determines "No" and sets continuity verification success information to a true value (step S607 in FIG. 10), and ends the processing of FIG. 10. The continuity verification success information is information indicating whether continuity verification has succeeded.

When the generated hash value information does not match the previous-transfer hash value information included in the (p+1)-th transaction information in step S604 in FIG. 10, the receiving node device 10-j determines "No", sets continuity verification success information to a false value (step S606 in FIG. 10), and ends the processing of FIG. 10.

Next, the receiving node device 10-j determines whether the continuity verification success information is set to a true value (step S404 in FIG. 8). When the continuity verification success information is set to a true value, the receiving node device 10-j determines "Yes" in step S404 in FIG. 8 and executes issuance verification (step S405 in FIG. 8). In order to execute issuance verification, the receiving node device 10-j executes processing illustrated in FIG. 11.

In the processing of FIG. 11, first, the receiving node device 10-j generates hash value information (in this example, double hash value information) by inputting first transaction information to the hash function (step S701 in FIG. 11).

Next, the receiving node device 10-j determines whether the hash value information generated in step S701 in FIG. 11 matches issuance hash value information obtained in advance (step S702 in FIG. 11).

When the generated hash value information matches the issuance hash value information obtained in advance, the receiving node device 10-j determines "Yes" in step S702 in FIG. 11, sets issuance verification success information to a true value (step S703 in FIG. 11), and ends the processing of FIG. 11. The issuance verification success information is information indicating whether issuance verification has succeeded.

When the generated hash value information does not match the issuance hash value information obtained in advance, the receiving node device 10-j determines "No" in step S702 in FIG. 11, sets issuance verification success information to a false value (step S704 in FIG. 11), and ends the processing of FIG. 11.

Next, the receiving node device 10-j determines whether issuance verification success information is set to a true value (step S406 in FIG. 8). When issuance verification success information is set to a true value, the receiving node device 10-j determines "Yes" in step S406 in FIG. 8 and executes rule verification (step S407 in FIG. 8). In order to execute rule verification, the receiving node device 10-j executes processing illustrated in FIG. 12.

In the processing of FIG. 12, first, the receiving node device 10-j sets counter information p to 1 (step S801 in FIG. 12). Next, the receiving node device 10-j determines whether the counter information p is smaller than M+2, which is a value obtained by adding 2 to the number of transactions M (step S802 in FIG. 12).

At this point, the counter information p is smaller than M+2. Accordingly, the receiving node device 10-j determines "Yes" in step S802 in FIG. 12 and determines whether token transfer information included in p-th transaction information complies with rules represented by rule information obtained in advance (in this example, the token rule set) (step S803 in FIG. 12).

When the token transfer information included in p-th transaction information complies with the rules, the receiving node device 10-j determines "Yes" in step S803 in FIG. 12, sets the counter information p to p+1 (in other words, increments the counter information p by 1) (step S804 in FIG. 12), returns to step S802 in FIG. 12, and repeatedly executes steps S802 to S804.

Thereafter, when the receiving node device 10-j proceeds to step S802 in FIG. 12 with the counter information p equal to M+2, the receiving node device 10-j determines "No" and sets rule verification success information to a true value (step S806 in FIG. 12), and ends the processing of FIG. 12. The rule verification success information is information indicating whether rule verification has succeeded.

When the token transfer information included in p-th transaction information does not comply with the rules in step S803 in FIG. 12, the receiving node device 10-j determines "No", sets rule verification success information to a false value (step S805 in FIG. 12), and ends the processing of FIG. 12.

Next, the receiving node device 10-j determines whether the rule verification success information is set to a true value (step S408 in FIG. 8). When the rule verification success information is set to a true value, the receiving node device 10-j determines "Yes" and sets token transfer verification success information to a true value (step S409 in FIG. 8), and ends the processing of FIG. 8. The token transfer verification success information is information indicating whether token transfer verification has succeeded.

When the record verification success information is set to a false value in step S402 in FIG. 8, when the continuity verification success information is set to a false value in step S404 in FIG. 8, when the issuance verification success information is set to a false value in step S406 in FIG. 8, or when the rule verification success information is set to a false value in step S408 in FIG. 8, the receiving node device 10-j determines "No," sets token transfer verification success information to a false value (step S410 in FIG. 8), and ends the processing of FIG. 8.

Next, the receiving node device 10-j proceeds to step S305 in FIG. 7 and determines whether the token transfer verification success information is set to a true value (step S305 in FIG. 7). When the token transfer verification success information is set to a true value, the receiving node device 10-j determines "Yes" and transmits, by broadcast, the new transaction information received in step S303 in FIG. 7 to the node devices (step S106 in FIG. 5 and step S306 in FIG. 7).

Next, the receiving node device 10-j transmits a confirmation request to the node devices (step S107 in FIG. 5 and step S307 in FIG. 7). Next, the receiving node device 10-j waits until a confirmation reply is received from the node devices (the determination of "No" is repeated in step S308 in FIG. 7).

When the node devices receive the confirmation request from the receiving node device 10-j, the node devices transmit a confirmation reply to the receiving node device 10-j in response to receipt of the confirmation request (step S108 in FIG. 5). Accordingly, the receiving node device 10-j receives the confirmation reply from the node devices (step S108 in FIG. 5). Therefore, the receiving node device 10-j determines "Yes" in step S308 in FIG. 7 and determines whether the received confirmation reply indicates that the new transaction information is recorded in the distributed ledger (step S309 in FIG. 7).

At this point, the new transaction information is not recorded in the distributed ledger. Accordingly, the receiving node device 10-j determines "No" in step S309 in FIG. 7, returns to step S307 in FIG. 7, and repeatedly executes steps S307 to S309.

Thereafter, the node devices verify that the coin transfer represented by the new transaction information is a valid transfer of a coin issued by a true issuer, and record the new transaction information in the distributed ledger (step S109 in FIG. 5).

Thereafter, the receiving node device 10-j transmits a confirmation request to the node devices (step S110 in FIG. 5 and step S307 in FIG. 7). Accordingly, the node devices transmit a confirmation reply to the receiving node device 10-j in response to receipt of the confirmation request (step S111 in FIG. 5). Accordingly, the receiving node device 10-j receives the confirmation reply from the node devices (step S111 in FIG. 5).

At this point, the new transaction information is recorded in the distributed ledger. Accordingly, the receiving node device 10-j determines "Yes" in step S309 in FIG. 7 and transmits a transfer approval notification to the granting node device 10-i (step S112 in FIG. 5 and step S310 in FIG. 7).

Accordingly, the granting node device 10-i receives the transfer result notification, which is the transfer approval notification, from the receiving node device 10-j (step S112 in FIG. 5). Therefore, the granting node device 10-i determines "Yes" in step S205 in FIG. 6 and determines whether the received transfer result notification indicates approval of the transfer (in other words, is the transfer approval notification) (step S206 in FIG. 6).

At this point, the received transfer result notification indicates approval of the transfer. Accordingly, the granting node device 10-i determines "Yes" in step S206 in FIG. 6, outputs transfer approval information (step S207 in FIG. 6), and ends the processing of FIG. 6.

On the other hand, after transmitting the transfer approval notification to the granting node device 10-i (step S112 in FIG. 5 and step S310 in FIG. 7), the receiving node device 10-j updates the transaction history information by adding the new transaction information received in step S303 in FIG. 7 to the transaction history information received in step S303 in FIG. 7, and stores the updated transaction history information (step S113 in FIG. 5 and step S311 in FIG. 7).

Next, the receiving node device 10-j returns to step S301 in FIG. 7 and repeatedly executes steps S301 to S312.

When the token transfer verification success information is set to a false value in step S305 in FIG. 7, the receiving node device 10-j determines "No," transmits a transfer failure notification to the granting node device 10-i (step S312 in FIG. 7), and returns to step S301 in FIG. 7.

In this case, when the granting node device 10-i proceeds to step S206 in FIG. 6, the granting node device 10-i determines "No," outputs transfer failure information (step S208 in FIG. 6), and ends the processing of FIG. 6. The order in which record verification, continuity verification, issuance verification, and rule verification are executed may be different from the order illustrated in FIG. 8.

As described above, in the information processing system 1 according to the first embodiment, the plurality of node devices 10-1, 10-2, ..., 10-N each having a plurality of wallets communicate according to a peer-to-peer scheme, and transaction information representing transfer of a token associated with a coin between two wallets among the plurality of wallets is recorded in a distributed ledger constituted by a blockchain.

A first node device having a first wallet (in this example, the granting node device 10-i) includes a generation unit (in this example, the transaction information generation unit 113) and a transmission unit (in this example, the transaction information transmission unit 114).

The generation unit generates new transaction information that is transaction information representing transfer of a token from the first wallet to a second wallet.

The transmission unit transmits, to a second node device having the second wallet (in this example, the receiving node device 10-j), the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history.

The second node device includes a receiving unit (in this example, the transaction information receiving unit 123) and a verification unit (in this example, the transaction information verification unit 126). The receiving unit receives the new transaction information and the transaction history information. Based on the received new transaction information and the received transaction history information, the verification unit executes token transfer verification to verify that transfer of the token to the second wallet is a valid transfer of the token issued by a true issuer.

According to this configuration, new transaction information and transaction history information are transmitted from the first node device to the second node device, and the second node device verifies that the token transfer is a valid transfer of a token issued by a true issuer (in other words, validity of the token transfer). Thus, validity of the token transfer can be verified without extracting transaction information related to a token from all transaction information recorded in the distributed ledger. Accordingly, the load for verifying validity of the token transfer can be reduced.

Further, in the information processing system 1 according to the first embodiment, the transaction information includes previous-transfer hash value information generated by inputting, to a hash function, transaction information representing a transfer immediately prior to a transfer represented by the transaction information. Further, the verification unit executes token transfer verification by executing continuity verification that verifies, for each transaction information pair, of transaction information pairs, each transaction information pair consisting of two transaction information pieces representing two consecutive transfers among a plurality of transaction information pieces consisting of the new transaction information and the group of transaction information pieces included in the transaction history information, that hash value information generated by inputting, to the hash function, transaction information representing a preceding transfer matches previous-transfer hash value information included in transaction information representing a subsequent transfer.

According to this configuration, it is possible to verify with high accuracy that a plurality of transfers represented by a plurality of transaction information pieces consisting of the new transaction information and the group of transaction information pieces included in the transaction history information are continuous. As a result, it is possible to verify with high accuracy validity of the token transfer to the second wallet.

Further, in the information processing system 1 according to the first embodiment, the second node device includes an obtaining unit (in this example, the issuance hash value information obtaining unit 124) configured to obtain issuance hash value information generated by inputting, to a hash function, transaction information representing issuance of the token. Further, the verification unit executes token transfer verification by executing issuance verification that verifies that hash value information generated by inputting, to the hash function, transaction information that is included in the transaction history information and represents issuance of the token matches the obtained issuance hash value information.

According to this configuration, it is possible to verify with high accuracy that the token was issued by a true issuer. As a result, it is possible to verify with high accuracy validity of the token transfer to the second wallet.

Further, in the information processing system 1 according to the first embodiment, the transaction information includes token transfer information representing transfer of the token. Further, the second node device includes an obtaining unit (in this example, the rule information obtaining unit 125) configured to obtain rule information representing rules to be complied with by token transfer information included in transaction information. Further, the verification unit executes token transfer verification by executing rule verification that verifies, for each of a plurality of transaction information pieces consisting of the new transaction information and the group of transaction information pieces included in the transaction history information, that token transfer information included in the transaction information piece complies with the rules represented by the obtained rule information.

According to this configuration, it is possible to verify with high accuracy that token transfer information included in each of a plurality of transaction information pieces consisting of the new transaction information and the group of transaction information pieces included in the transaction history information complies with the rules. As a result, it is possible to verify with high accuracy validity of the token transfer to the second wallet.

Further, in the information processing system 1 according to the first embodiment, the verification unit executes token transfer verification by executing record verification that verifies that transaction information that is included in the transaction history information and represents a transfer immediately prior to the transfer represented by the new transaction information is recorded in the distributed ledger.

According to this configuration, it is possible to verify with high accuracy that the coin transfer represented by transaction information representing a token transfer immediately prior to the token transfer from the first wallet to the second wallet is a valid coin transfer of a coin issued by a true issuer. As a result, it is possible to verify with high accuracy validity of the token transfer to the second wallet.

Further, in the information processing system 1 according to the first embodiment, the second node device includes a transmission unit (in this example, the broadcast transmission unit 127) configured to, when token transfer verification succeeds, transmit the new transaction information by broadcast and, when token transfer verification fails, not transmit the new transaction information.

According to this configuration, it is possible to reduce recording, in the distributed ledger, transaction information for which token transfer verification has failed.

### First Modification of First Embodiment

Next, an information processing system according to a first modification of the first embodiment will be described. The information processing system according to the first modification differs from the information processing system according to the first embodiment in that execution of the same verification is omitted for transaction information for which issuance verification or rule verification has already succeeded. Differences will be mainly described below. In the description of the first modification of the first embodiment, components given the same reference numerals as those used in the first embodiment are the same as or substantially similar to those described above.

### Functions

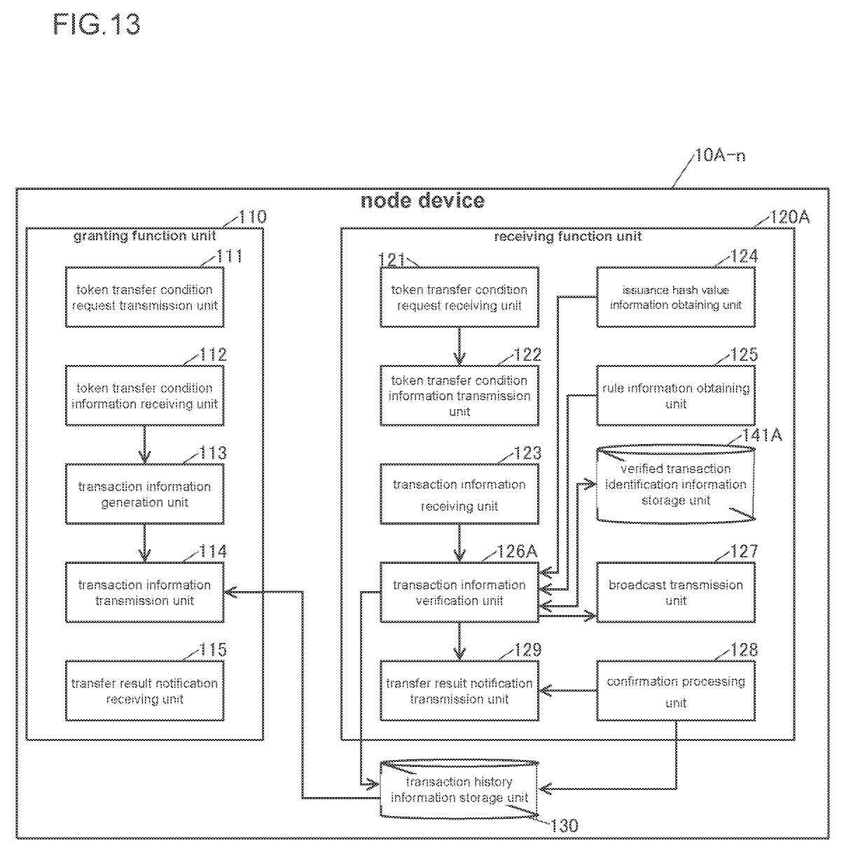

As illustrated in FIG. 13, functions of a node device 10A-n according to the first modification of the first embodiment are functions in which, among the functions of the node device 10-n according to the first embodiment, the receiving function unit 120 is replaced with a receiving function unit 120A.

The receiving function unit 120A includes a verified transaction identification information storage unit 141A in addition to the functions of the receiving function unit 120 of the first embodiment, and, in the receiving function unit 120 of the first embodiment, the transaction information verification unit 126 is replaced with a transaction information verification unit 126A.

When issuance verification for transaction information succeeds, the verified transaction identification information storage unit 141A stores verified transaction identification information identifying the transaction information. In this example, the verified transaction identification information identifying transaction information is hash value information (in this example, double hash value information) generated by inputting the transaction information to a hash function.

Further, when rule verification for transaction information succeeds, the verified transaction identification information storage unit 141A stores verified transaction identification information identifying the transaction information.

The transaction information verification unit 126A has the same functions as the transaction information verification unit 126 of the first embodiment. Further, the transaction information verification unit 126A omits execution of issuance verification for transaction information identified by verified transaction identification information stored in the verified transaction identification information storage unit 141A.

Further, the transaction information verification unit 126A omits execution of rule verification for transaction information identified by verified transaction identification information stored in the verified transaction identification information storage unit 141A.

The transaction information verification unit 126A may omit only one of execution of issuance verification and execution of rule verification.

### Operation

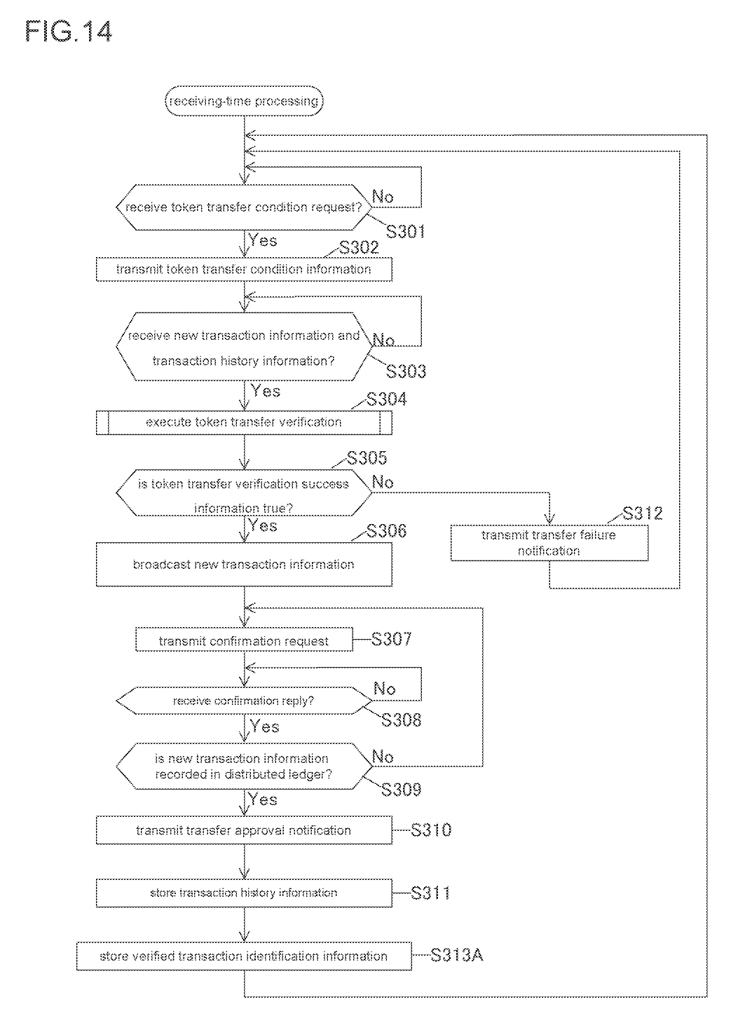

A receiving node device 10A-j according to the first modification of the first embodiment executes processing illustrated in FIG. 14 instead of the processing illustrated in FIG. 7. The processing of FIG. 14 is processing in which step S313A is added immediately after step S311 in the processing of FIG. 7.

In the processing of FIG. 14, after executing the processing of step S311 in FIG. 14, the receiving node device 10A-j generates hash value information (in this example, double hash value information) by inputting each of a plurality of transaction information pieces consisting of new transaction information received in step S303 in FIG. 14 and the group of transaction information pieces included in transaction history information received in step S303 in FIG. 14 to the hash function, and stores the generated hash value information as verified transaction identification information (step S313A in FIG. 14). Thereafter, the receiving node device 10A-j returns to step S301 in FIG. 14.

The processing of step S313A in FIG. 14 may be executed during steps S306 to S311 in FIG. 14. Further, even when token transfer verification fails, the receiving node device 10A-j may store verified transaction identification information for transaction information when issuance verification or rule verification for the transaction information succeeds.

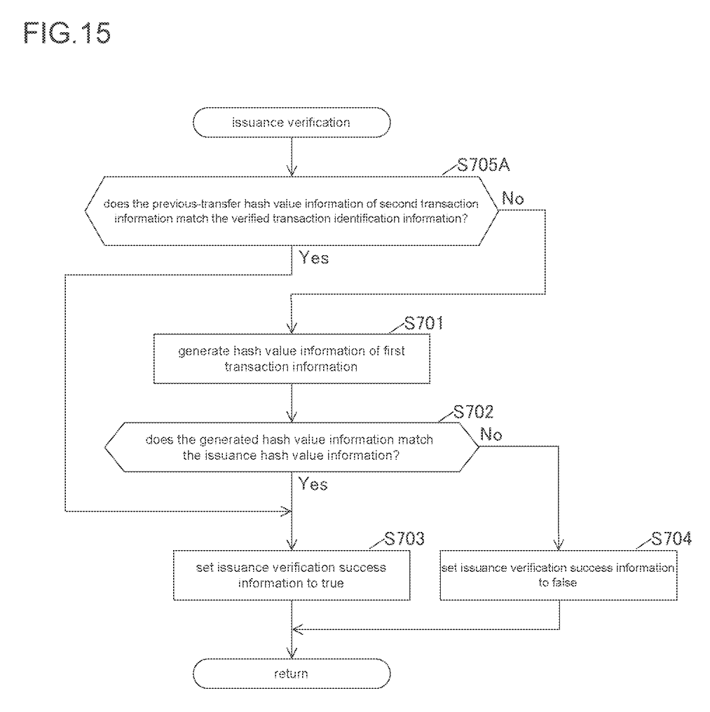

Further, the receiving node device 10A-j according to the first modification of the first embodiment executes processing illustrated in FIG. 15 instead of the processing illustrated in FIG. 11. The processing of FIG. 15 is processing in which step S705A is added immediately before step S701 in the processing of FIG. 11.

In the processing of FIG. 15, first, the receiving node device 10A-j determines whether previous-transfer hash value information (in this example, previous-transfer information) included in second transaction information matches any of stored verified transaction identification information (step S705A in FIG. 15).

When the previous-transfer hash value information matches any of the stored verified transaction identification information, the receiving node device 10A-j determines "Yes" in step S705A in FIG. 15 and proceeds to step S703 in FIG. 15. Thereby, execution of processing of steps S701 to S702 in FIG. 15 is omitted.

On the other hand, when the previous-transfer hash value information does not match any of the stored verified transaction identification information, the receiving node device 10A-j determines "No" in step S705A in FIG. 15 and proceeds to step S701 in FIG. 15.

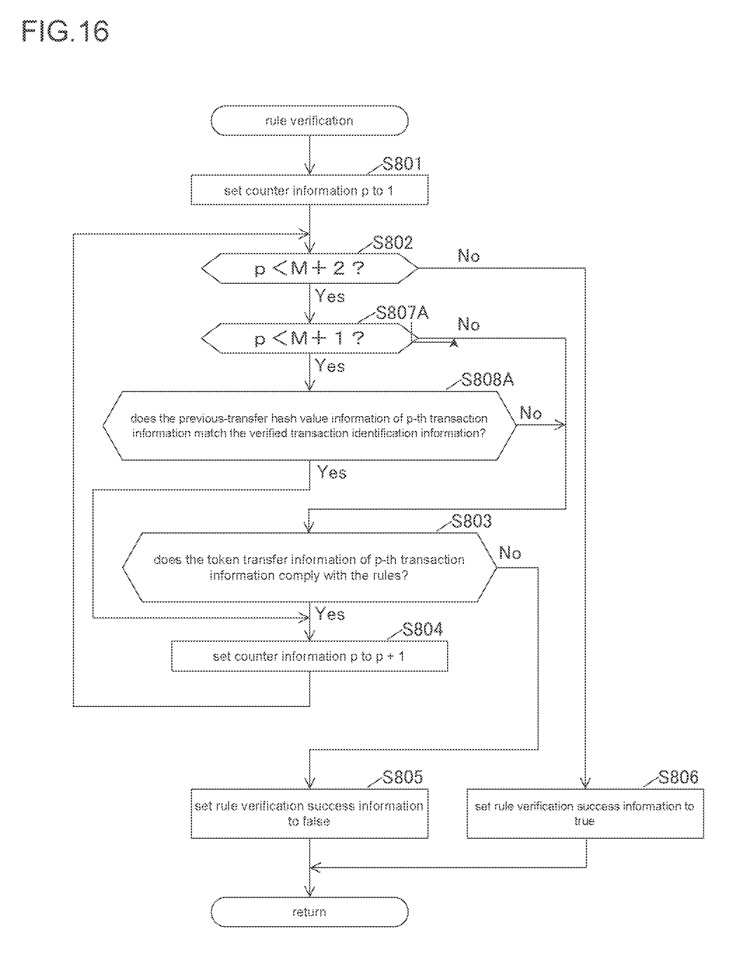

Further, the receiving node device 10A-j according to the first modification of the first embodiment executes processing illustrated in FIG. 16 instead of the processing illustrated in FIG. 12. The processing of FIG. 16 is processing in which steps S807A to S808A are added immediately after the determination of "Yes" in step S802 in the processing of FIG. 12.

In the processing of FIG. 16, when determining "Yes" in step S802 in FIG. 16, the receiving node device 10A-j determines whether counter information p is smaller than M+1, which is a value obtained by adding 1 to the number of transactions M (step S807A in FIG. 16).

When the counter information p is smaller than M+1, the receiving node device 10A-j determines "Yes" in step S807A in FIG. 16 and determines whether previous-transfer hash value information (in this example, previous-transfer information) included in p-th transaction information matches any of stored verified transaction identification information (step S808A in FIG. 16).

When the previous-transfer hash value information matches any of the stored verified transaction identification information, the receiving node device 10A-j determines "Yes" in step S808A in FIG. 16 and proceeds to step S804 in FIG. 16. Thereby, execution of processing of step S803 in FIG. 16 is omitted.

On the other hand, when the previous-transfer hash value information does not match any of the stored verified transaction identification information, the receiving node device 10A-j determines "No" in step S808A in FIG. 16 and proceeds to step S803 in FIG. 16.

When the counter information p is equal to M+1, the receiving node device 10A-j determines "No" in step S807A in FIG. 16 and proceeds to step S803 in FIG. 16.

As described above, the information processing system 1 according to the first modification of the first embodiment provides the same effects as those of the information processing system 1 according to the first embodiment. Further, in the information processing system 1 according to the first modification of the first embodiment, when issuance verification for transaction information succeeds, the second node device (in this example, the receiving node device 10A-j) includes the verified transaction identification information storage unit 141A configured to store verified transaction identification information identifying the transaction information. Further, the verification unit (in this example, the transaction information verification unit 126A) omits execution of issuance verification for transaction information identified by stored verified transaction identification information.

According to this configuration, when the second node device receives transaction history information including transaction information for which issuance verification has already succeeded, execution of issuance verification for the transaction information is omitted. Thereby, the load for verifying validity of the token transfer can be reduced. Further, validity of the token transfer can be quickly verified.

Further, in the information processing system 1 according to the first modification of the first embodiment, when rule verification for transaction information succeeds, the second node device includes the verified transaction identification information storage unit 141A configured to store verified transaction identification information identifying the transaction information. Further, the verification unit omits execution of rule verification for transaction information identified by stored verified transaction identification information.

According to this configuration, when the second node device receives transaction history information including transaction information for which rule verification has already succeeded, execution of rule verification for the transaction information is omitted. Thereby, the load for verifying validity of the token transfer can be reduced. Further, validity of the token transfer can be quickly verified.

### Second Modification of First Embodiment

Next, an information processing system according to a second modification of the first embodiment will be described. The information processing system according to the second modification differs from the information processing system according to the first embodiment in that execution of a portion corresponding to transaction history information for which token transfer verification has already succeeded among token transfer verification is omitted. Differences will be mainly described below. In the description of the second modification of the first embodiment, components given the same reference numerals as those used in the first embodiment are the same as or substantially similar to those described above.

### Functions

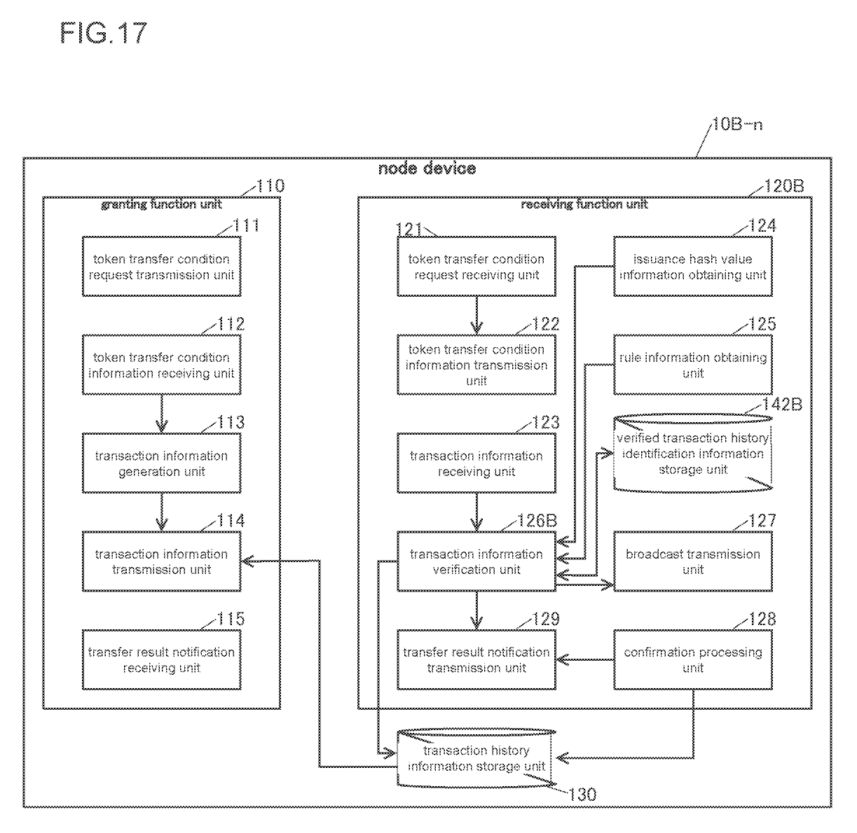

As illustrated in FIG. 17, functions of a node device 10B-n according to the second modification of the first embodiment are functions in which, among the functions of the node device 10-n according to the first embodiment, the receiving function unit 120 is replaced with a receiving function unit 120B.

The receiving function unit 120B includes a verified transaction history identification information storage unit 142B in addition to the functions of the receiving function unit 120 of the first embodiment, and, in the receiving function unit 120 of the first embodiment, the transaction information verification unit 126 is replaced with a transaction information verification unit 126B.

In this example, the transaction information includes transfer-history hash value information. Transfer-history hash value information included in transaction information representing transfer of a token is generated by inputting, to a hash function, transaction history information including a group of transaction information pieces corresponding to a history of transfers of the token from issuance of the token to a transfer immediately prior to a transfer represented by the transaction information, the transaction history information including the group of transaction information pieces in association with an order of transfers in the history.

In this example, the transfer-history hash value information is hash value information (in other words, double hash value information) generated by further inputting, to the hash function, hash value information generated by inputting the transaction history information to the hash function. The transfer-history hash value information may be hash value information (in other words, single hash value information) generated by inputting the transaction history information to the hash function.

When token transfer verification by the transaction information verification unit 126B succeeds for the new transaction information and the transaction history information received by the transaction information receiving unit 123, the verified transaction history identification information storage unit 142B stores verified transaction history identification information.

The verified transaction history identification information for the new transaction information and the transaction history information representing transfer of a token is information identifying transaction history information including a group of transaction information pieces corresponding to a history of transfers of the token from issuance of the token to a transfer represented by the new transaction information, the transaction history information including the group of transaction information pieces in association with an order of transfers in the history.

In this example, the verified transaction history identification information for the new transaction information and the transaction history information representing transfer of a token is hash value information (in this example, double hash value information) generated by inputting, to a hash function, transaction history information including a group of transaction information pieces corresponding to a history of transfers of the token from issuance of the token to the transfer represented by the new transaction information, the transaction history information including the group of transaction information pieces in association with an order of transfers in the history (in other words, transfer-history hash value information).

The transaction information verification unit 126B has the same functions as the transaction information verification unit 126 of the first embodiment. Further, the transaction information verification unit 126B omits, among token transfer verification for the new transaction information and the transaction history information received by the transaction information receiving unit 123, execution of a portion corresponding to transaction history information identified by verified transaction history identification information stored in the verified transaction history identification information storage unit 142B.

In this example, the transaction information verification unit 126B omits, among token transfer verification for the new transaction information and the transaction history information received by the transaction information receiving unit 123, execution of a portion corresponding to a portion of the history of transfers of the token from issuance of the token to a transfer immediately prior to the transfer represented by transaction information including transfer-history hash value information matching verified transaction history identification information stored in the verified transaction history identification information storage unit 142B.

### Operation

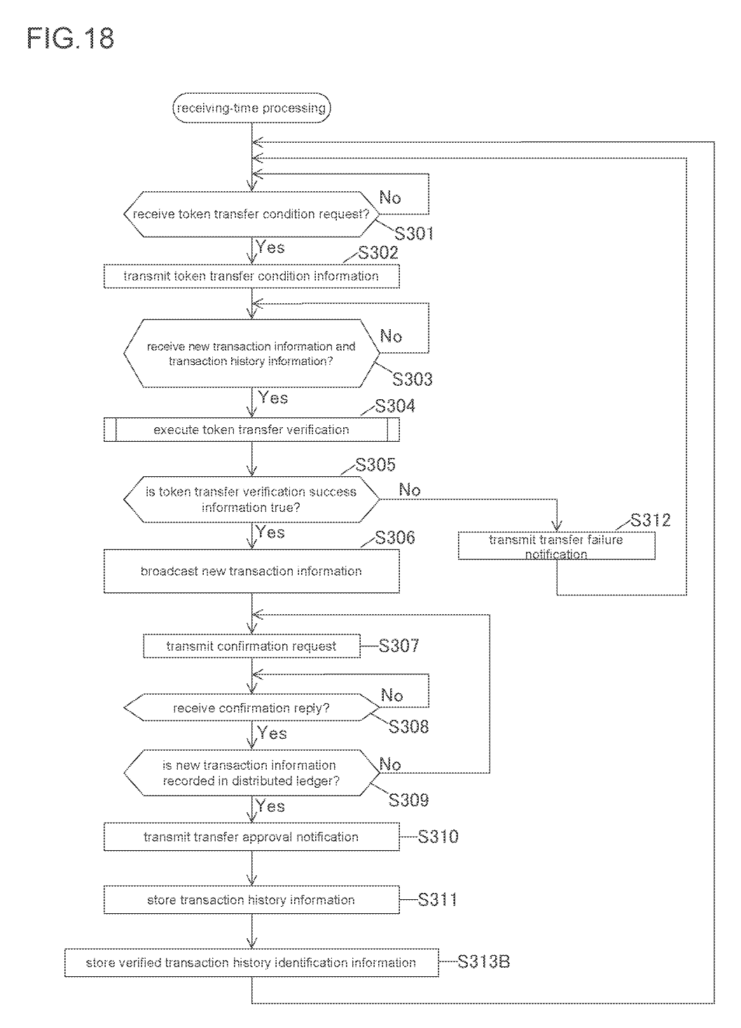

A receiving node device 10B-j according to the second modification of the first embodiment executes processing illustrated in FIG. 18 instead of the processing illustrated in FIG. 7. The processing of FIG. 18 is processing in which step S313B is added immediately after step S311 in the processing of FIG. 7.

In the processing of FIG. 18, after executing the processing of step S311 in FIG. 18, the receiving node device 10B-j generates hash value information (in this example, double hash value information) by inputting transaction history information stored in step S311 in FIG. 18 to a hash function, and stores the generated hash value information as verified transaction history identification information (step S313B in FIG. 18). Thereafter, the receiving node device 10B-j returns to step S301 in FIG. 18.

The processing of step S313B in FIG. 18 may be executed during steps S306 to S311 in FIG. 18.

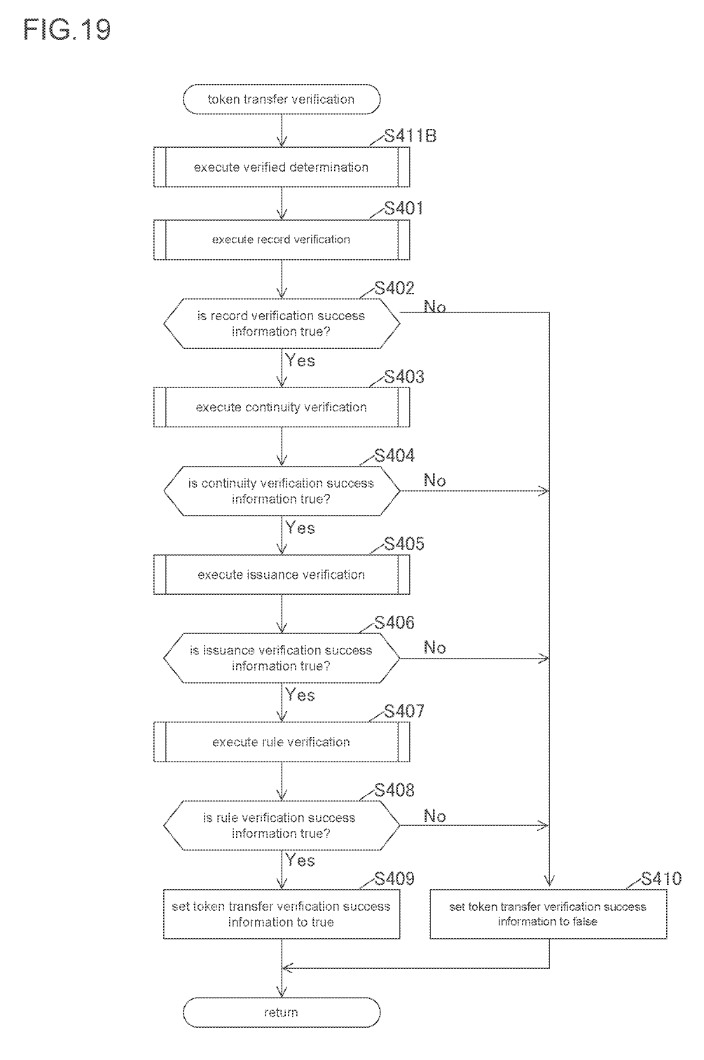

Further, the receiving node device 10B-j according to the second modification of the first embodiment executes processing illustrated in FIG. 19 instead of the processing illustrated in FIG. 8. The processing of FIG. 19 is processing in which step S411B is added immediately before step S401 in the processing of FIG. 8.

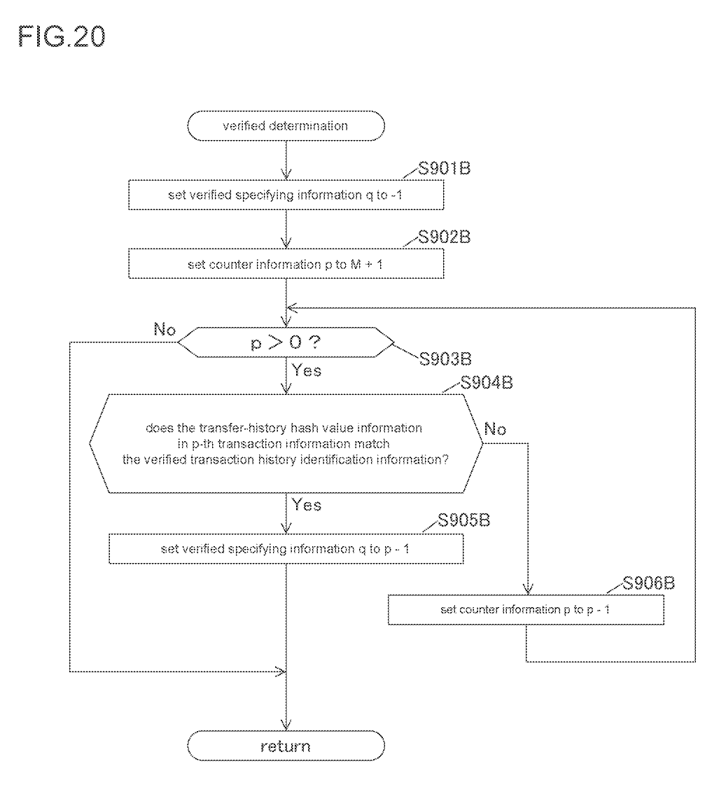

In the processing of FIG. 19, first, the receiving node device 10B-j executes verified determination (step S411B in FIG. 19). In order to execute verified determination, the receiving node device 10B-j executes processing illustrated in FIG. 20.

In the processing of FIG. 20, first, the receiving node device 10B-j sets verified specifying information q to -1 (step S901B in FIG. 20). In this example, the verified specifying information q represents an integer. Next, the receiving node device 10B-j sets counter information p to M+1, which is a value obtained by adding 1 to the number of transactions M (step S902B in FIG. 20).

Next, the receiving node device 10B-j determines whether the counter information p is greater than 0 (step S903B in FIG. 20). At this point, the counter information p is greater than 0. Accordingly, the receiving node device 10B-j determines "Yes" in step S903B in FIG. 20 and determines whether transfer-history hash value information included in p-th transaction information matches any of stored verified transaction history identification information (step S904B in FIG. 20).

When the transfer-history hash value information matches any of the stored verified transaction history identification information, the receiving node device 10B-j determines "Yes" in step S904B in FIG. 20, sets the verified specifying information q to p-1 (step S905B in FIG. 20), and ends the processing of FIG. 20.

On the other hand, when the transfer-history hash value information does not match any of the stored verified transaction history identification information, the receiving node device 10B-j determines "No" in step S904B in FIG. 20, sets the counter information p to p-1 (in other words, decrements the counter information p by 1) (step S906B in FIG. 20), returns to step S903B in FIG. 20, and repeatedly executes steps S903B to S906B.

When the counter information p is equal to 0 in step S903B in FIG. 20, the receiving node device 10B-j determines "No" and ends the processing of FIG. 20 without executing steps S904B to S906B in FIG. 20.

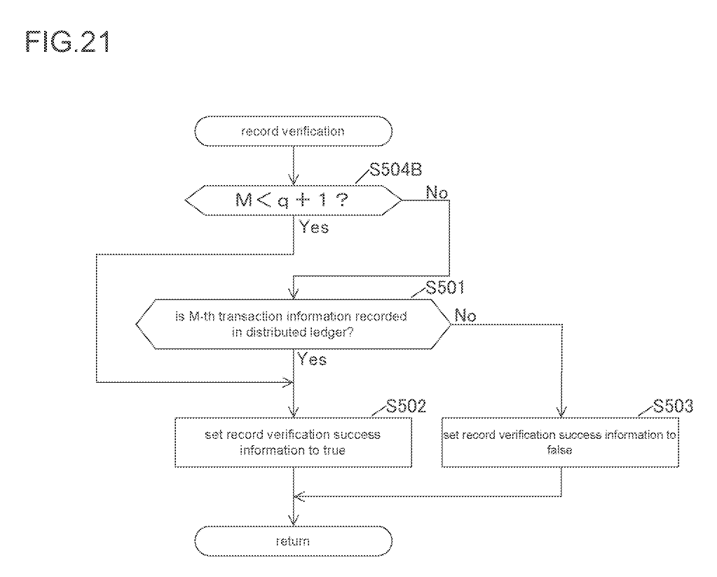

Thereafter, in step S401 in FIG. 19, the receiving node device 10B-j executes processing illustrated in FIG. 21 instead of the processing illustrated in FIG. 9. The processing of FIG. 21 is processing in which step S504B is added immediately before step S501 in the processing of FIG. 9.

In the processing of FIG. 21, first, the receiving node device 10B-j determines whether the number of transactions M is smaller than q+1, which is a value obtained by adding 1 to the verified specifying information q (step S504B in FIG. 21).

When the number of transactions M is smaller than q+1, the receiving node device 10B-j determines "Yes" in step S504B in FIG. 21 and proceeds to step S502 in FIG. 21. Thereby, execution of processing of step S501 in FIG. 21 is omitted.

On the other hand, when the number of transactions M is q+1 or greater, the receiving node device 10B-j determines "No" in step S504B in FIG. 21 and proceeds to step S501 in FIG. 21.

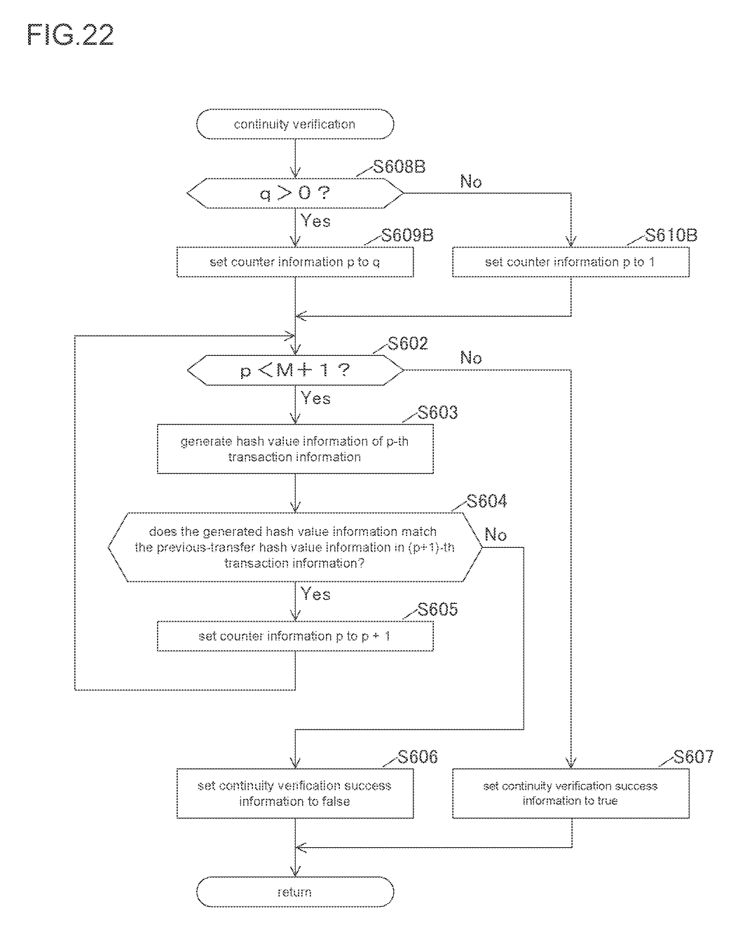

Thereafter, in step S403 in FIG. 19, the receiving node device 10B-j executes processing illustrated in FIG. 22 instead of the processing illustrated in FIG. 10. The processing of FIG. 22 is processing in which step S601 is replaced with steps S608B to S610B in the processing of FIG. 10.

In the processing of FIG. 22, first, the receiving node device 10B-j determines whether the verified specifying information q is greater than 0 (step S608B in FIG. 22).

When the verified specifying information q is greater than 0, the receiving node device 10B-j determines "Yes" in step S608B in FIG. 22 and sets the counter information p to the verified specifying information q (step S609B in FIG. 22). Next, the receiving node device 10B-j executes processing from step S602 in FIG. 22 onward. Thereby, execution of processing of steps S602 to S605 when the counter information p is 1 to q-1 is omitted.

On the other hand, when the verified specifying information q is 0 or less, the receiving node device 10B-j determines "No" in step S608B in FIG. 22 and sets the counter information p to 1 (step S610B in FIG. 22). Next, the receiving node device 10B-j executes processing from step S602 in FIG. 22 onward.

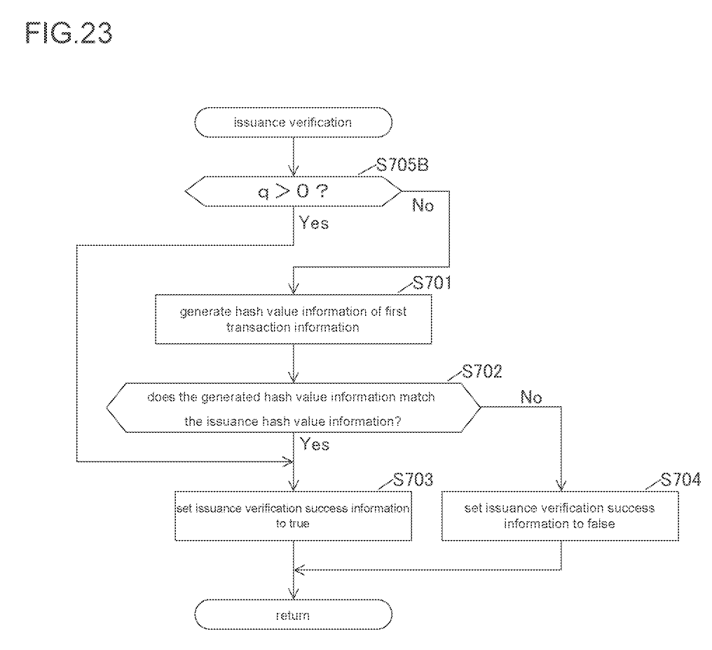

Thereafter, in step S405 in FIG. 19, the receiving node device 10B-j executes processing illustrated in FIG. 23 instead of the processing illustrated in FIG. 11. The processing of FIG. 23 is processing in which step S705B is added immediately before step S701 in the processing of FIG. 11.

In the processing of FIG. 23, first, the receiving node device 10B-j determines whether the verified specifying information q is greater than 0 (step S705B in FIG. 23).

When the verified specifying information q is greater than 0, the receiving node device 10B-j determines "Yes" in step S705B in FIG. 23 and proceeds to step S703 in FIG. 23. Thereby, execution of processing of steps S701 to S702 in FIG. 23 is omitted.

On the other hand, when the verified specifying information q is 0 or less, the receiving node device 10B-j determines "No" in step S705B in FIG. 23 and proceeds to step S701 in FIG. 23.

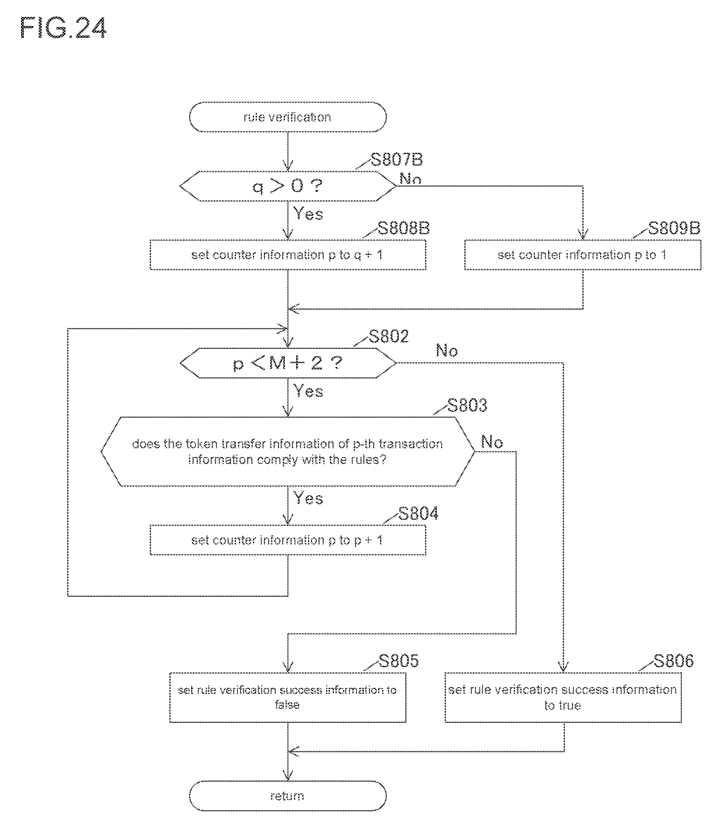

Thereafter, in step S407 in FIG. 19, the receiving node device 10B-j executes processing illustrated in FIG. 24 instead of the processing illustrated in FIG. 12. The processing of FIG. 24 is processing in which step S801 is replaced with steps S807B to S809B in the processing of FIG. 12.

In the processing of FIG. 24, first, the receiving node device 10B-j determines whether the verified specifying information q is greater than 0 (step S807B in FIG. 24).

When the verified specifying information q is greater than 0, the receiving node device 10B-j determines "Yes" in step S807B in FIG. 24 and sets the counter information p to q+1, which is a value obtained by adding 1 to the verified specifying information q (step S808B in FIG. 24). Next, the receiving node device 10B-j executes processing from step S802 in FIG. 24 onward. Thereby, execution of processing of steps S802 to S804 when the counter information p is 1 to q is omitted.

On the other hand, when the verified specifying information q is 0 or less, the receiving node device 10B-j determines "No" in step S807B in FIG. 24 and sets the counter information p to 1 (step S809B in FIG. 24). Next, the receiving node device 10B-j executes processing from step S802 in FIG. 24 onward.

As described above, the information processing system 1 according to the second modification of the first embodiment provides the same effects as those of the information processing system 1 according to the first embodiment. Further, in the information processing system 1 according to the second modification of the first embodiment, the second node device (in this example, the receiving node device 10B-j) includes the verified transaction history identification information storage unit 142B.

When token transfer verification for new transaction information and transaction history information succeeds, the verified transaction history identification information storage unit 142B stores verified transaction history identification information identifying transaction history information including a group of transaction information pieces corresponding to a history of transfers of the token from issuance of the token to the transfer represented by the new transaction information, the transaction history information including the group of transaction information pieces in association with an order of transfers in the history.

Further, the verification unit (in this example, the transaction information verification unit 126B) omits, among token transfer verification for the received new transaction information and the received transaction history information, execution of a portion corresponding to transaction history information identified by stored verified transaction history identification information.

According to this configuration, when the second node device receives second transaction history information including first transaction history information for which token transfer verification has already succeeded, execution of a portion corresponding to the first transaction history information among token transfer verification is omitted. Thereby, the load for verifying validity of the token transfer can be reduced. Further, validity of the token transfer can be quickly verified.

Further, in the information processing system 1 according to the second modification of the first embodiment, transaction information includes transfer-history hash value information generated by inputting, to a hash function, transaction history information including a group of transaction information pieces corresponding to a history of transfers of the token from issuance of the token to a transfer immediately prior to a transfer represented by the transaction information, the transaction history information including the group of transaction information pieces in association with an order of transfers in the history.

Further, as verified transaction history identification information identifying transaction history information, the verified transaction history identification information storage unit 142B uses transfer-history hash value information generated by inputting the transaction history information to the hash function.

Further, the verification unit omits, among token transfer verification for the received new transaction information and the received transaction history information, execution of a portion corresponding to a portion of the history of transfers of the token from issuance of the token to a transfer immediately prior to a transfer represented by transaction information including transfer-history hash value information matching stored verified transaction history identification information.

According to this configuration, the second node device can determine, by determining whether transfer-history hash value information included in the received new transaction information and the received transaction history information matches stored verified transaction history identification information, a portion whose execution is omitted among token transfer verification. Accordingly, the load for verifying validity of the token transfer can be reduced. Further, validity of the token transfer can be quickly verified.

### Second Embodiment

Next, an information processing system according to a second embodiment will be described. The information processing system according to the second embodiment differs from the information processing system according to the first embodiment in that a transfer approval notification is transmitted from a receiving node device to a granting node device before new transaction information is recorded in a distributed ledger. Differences will be mainly described below. In the description of the second embodiment, components given the same reference numerals as those used in the first embodiment are the same as or substantially similar to those described above.

In the information processing system 1 according to the second embodiment, a wallet is an SPV (Simplified Payment Verification) wallet.

### Operation

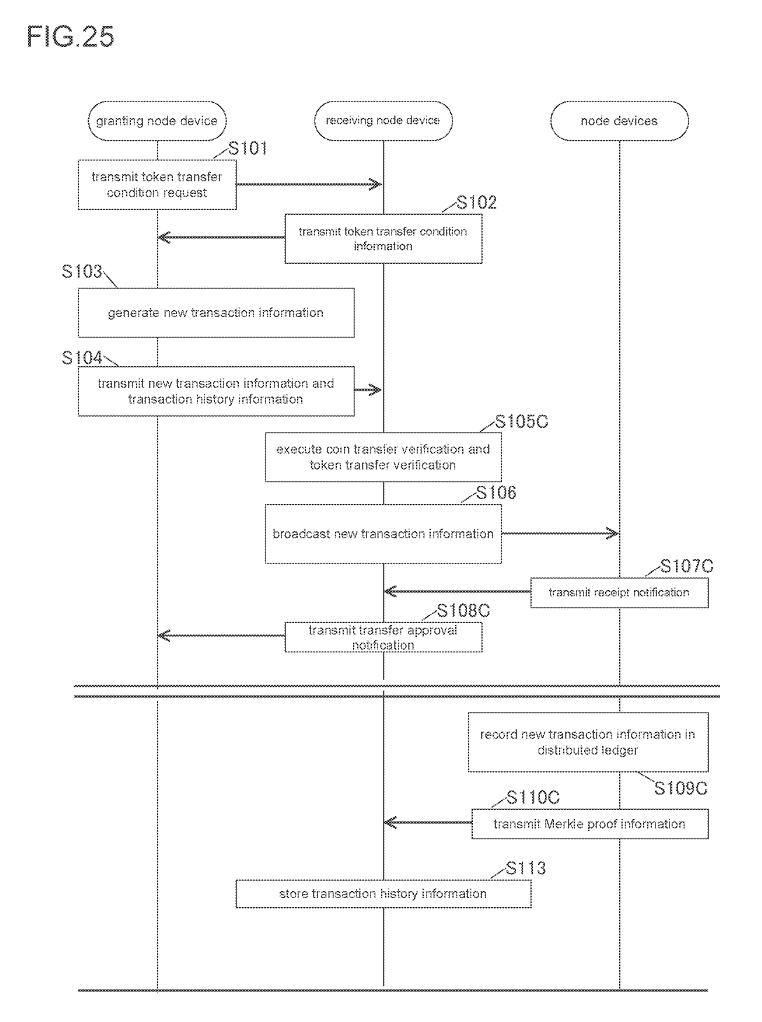

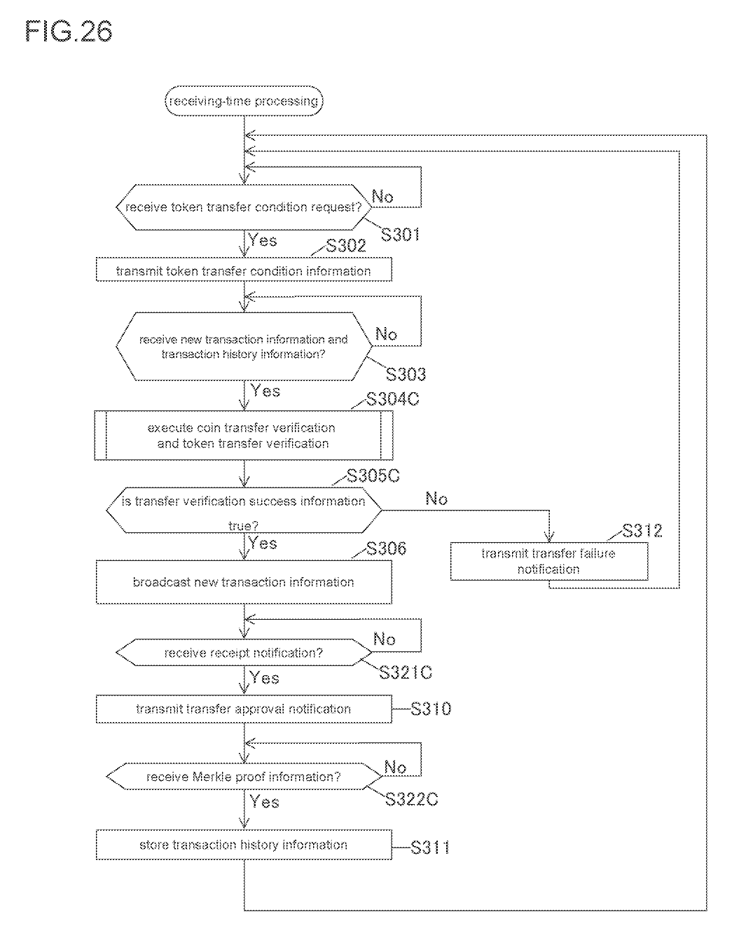

An operation of the information processing system 1 according to the second embodiment will be described with reference to FIGS. 25 and 26. FIG. 25 is a sequence diagram illustrating an example of an operation of the information processing system 1. FIG. 26 is a flowchart illustrating an example of receiving-time processing executed by the receiving node device 10-j.

The granting node device 10-i according to the second embodiment executes the granting-time processing illustrated in FIG. 6, similarly to the granting node device 10-i according to the first embodiment. Further, the receiving node device 10-j according to the second embodiment executes processing illustrated in FIG. 26 instead of the processing illustrated in FIG. 7.

In the processing of FIG. 26, processing of steps S301 to S303 is the same processing as steps S301 to S303 in FIG. 7. Accordingly, the information processing system 1 according to the second embodiment executes the processing of steps S101 to S104 in FIG. 25 similarly to the first embodiment.

Next, the receiving node device 10-j executes coin transfer verification and token transfer verification (step S105C in FIG. 25 and step S304C in FIG. 26). In this example, the coin transfer verification includes verifying that a coin transfer represented by the new transaction information is a valid coin transfer of a coin issued by a true issuer.

In this example, the token transfer verification is the same processing as the processing of FIG. 8 executed by the receiving node device 10-j according to the first embodiment. The token transfer verification may be token transfer verification executed by the receiving node device 10A-j according to the first modification of the first embodiment. The token transfer verification may be token transfer verification executed by the receiving node device 10B-j according to the second modification of the first embodiment.

When both the coin transfer verification and the token transfer verification succeed, the receiving node device 10-j sets transfer verification success information to a true value. When at least one of the coin transfer verification and the token transfer verification fails, the receiving node device 10-j sets transfer verification success information to a false value. The transfer verification success information is information indicating whether both the coin transfer verification and the token transfer verification have succeeded.

Next, the receiving node device 10-j determines whether the transfer verification success information is set to a true value (step S305C in FIG. 26). When the transfer verification success information is set to a true value, the receiving node device 10-j determines "Yes" and transmits, by broadcast, the new transaction information received in step S303 in FIG. 26 to the node devices (step S106 in FIG. 25 and step S306 in FIG. 26).

Next, the receiving node device 10-j waits until a receipt notification is received from the node devices (the determination of "No" is repeated in step S321C in FIG. 26). The receipt notification is information indicating that the node devices have received the new transaction information.

When the node devices receive the new transaction information from the receiving node device 10-j, the node devices transmit a receipt notification to the receiving node device 10-j in response to receipt of the new transaction information (step S107C in FIG. 25). Accordingly, the receiving node device 10-j receives the receipt notification from the node devices (step S107C in FIG. 25). Therefore, the receiving node device 10-j determines "Yes" in step S321C in FIG. 26 and transmits a transfer approval notification to the granting node device 10-i (step S108C in FIG. 25 and step S310 in FIG. 26).

Next, the receiving node device 10-j waits until Merkle proof information indicating that the new transaction information is recorded in the distributed ledger is received from the node devices (the determination of "No" is repeated in step S322C in FIG. 26). In this example, the Merkle proof information is generated using a data structure referred to as a Merkle tree. The Merkle proof information may also be referred to as a Merkle proof.

Thereafter, the node devices verify that the coin transfer represented by the new transaction information is a valid coin transfer of a coin issued by a true issuer, and record the new transaction information in the distributed ledger (step S109C in FIG. 25). Next, the node devices generate Merkle proof information indicating that the new transaction information is recorded in the distributed ledger and transmit the generated Merkle proof information to the receiving node device 10-j (step S110C in FIG. 25).

Accordingly, the receiving node device 10-j receives the Merkle proof information from the node devices (step S110C in FIG. 25). Therefore, the receiving node device 10-j determines "Yes" in step S322C in FIG. 26 and updates the transaction history information by adding the new transaction information received in step S303 in FIG. 26 to the transaction history information received in step S303 in FIG. 26, and stores the updated transaction history information (step S113 in FIG. 25 and step S311 in FIG. 26).

Next, the receiving node device 10-j returns to step S301 in FIG. 26 and repeatedly executes the processing from step S301 onward.

When the transfer verification success information is set to a false value in step S305C in FIG. 26, the receiving node device 10-j determines "No," transmits a transfer failure notification to the granting node device 10-i (step S312 in FIG. 26), and returns to step S301 in FIG. 26.

As described above, the information processing system 1 according to the second embodiment provides the same effects as those of the information processing system 1 according to the first embodiment, the first modification of the first embodiment, or the second modification of the first embodiment.

The present disclosure is not limited to the embodiments described above. For example, various modifications that a person skilled in the art can understand may be made to the embodiments described above without departing from the spirit of the present disclosure.

### REFERENCE SIGNS LIST

1: information processing system

10-1, 10-2, ..., 10-N: node device

10A-1, 10A-2, ..., 10A-N: node device

10B-1, 10B-2, ..., 10B-N: node device

10-i: granting node device

10-j: receiving node device

11: processing device

12: storage device

13: input device

14: output device

15: communication device

110: granting function unit

111: token transfer condition request transmission unit

112: token transfer condition information receiving unit

113: transaction information generation unit

114: transaction information transmission unit

115: transfer result notification receiving unit

120, 120A, 120B: receiving function unit

121: token transfer condition request receiving unit

122: token transfer condition information transmission unit

123: transaction information receiving unit

124: issuance hash value information obtaining unit

125: rule information obtaining unit

126, 126A, 126B: transaction information verification unit

127: broadcast transmission unit

128: confirmation processing unit

129: transfer result notification transmission unit

130: transaction history information storage unit

141A: verified transaction identification information storage unit

142B: verified transaction history identification information storage unit

BU: bus

NW: communication line

1. An information processing system for recording, in a distributed ledger constituted by a blockchain, transaction information representing transfer of a token associated with a coin between two wallets among a plurality of wallets, wherein a plurality of node devices each including at least one of the plurality of wallets communicate according to a peer-to-peer scheme, the information processing system comprising:
a first node device including a first wallet, the first node device comprising:
a generator configured to generate new transaction information that is transaction information representing transfer of the token from the first wallet to a second wallet; and
a first transmitter configured to transmit, to a second node device including the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history; and
the second node device, comprising:
a receiver configured to receive the new transaction information and the transaction history information; and
verification processor circuitry configured to execute token transfer verification, based on the received new transaction information and the received transaction history information, to verify that the transfer of the token to the second wallet is a valid transfer of the token issued by a true issuer.

2. The information processing system according to claim 1, wherein the transaction information includes previous-transfer hash value information generated by inputting, to a hash function, transaction information representing a transfer immediately prior to a transfer represented by the transaction information, and
wherein the verification processor circuitry executes the token transfer verification by executing continuity verification that verifies, for each transaction information pair, of transaction information pairs, each transaction information pair consisting of two transaction information pieces representing two consecutive transfers among a plurality of transaction information pieces consisting of the new transaction information and the group of transaction information pieces included in the transaction history information, that hash value information generated by inputting, to the hash function, transaction information representing a preceding transfer matches previous-transfer hash value information included in transaction information representing a subsequent transfer.

3. The information processing system according to claim 1, wherein the second node device comprises obtaining processor circuitry configured to obtain issuance hash value information generated by inputting, to a hash function, transaction information representing issuance of the token, and
wherein the verification processor circuitry executes the token transfer verification by executing issuance verification that verifies that hash value information generated by inputting, to the hash function, transaction information that is included in the transaction history information and represents issuance of the token matches the obtained issuance hash value information.

4. The information processing system according to claim 3, wherein the second node device comprises a verified transaction identification information storage configured to store verified transaction identification information identifying transaction information when the issuance verification for the transaction information succeeds, and
wherein the verification processor circuitry omits execution of the issuance verification for transaction information identified by the stored verified transaction identification information.

5. The information processing system according to claim 1, wherein the transaction information includes token transfer information representing transfer of the token,
wherein the second node device comprises obtaining processor circuitry configured to obtain rule information representing rules to be complied with by the token transfer information, and
wherein the verification processor circuitry executes the token transfer verification by executing rule verification that verifies, for each of the plurality of transaction information pieces, that token transfer information included in the transaction information piece complies with the rules represented by the obtained rule information, the plurality of transaction information pieces consisting of the new transaction information and the group of transaction information pieces included in the transaction history information.

6. The information processing system according to claim 5, wherein the second node device comprises a verified transaction identification information storage configured to store verified transaction identification information identifying transaction information when the rule verification for the transaction information succeeds, and
wherein the verification processor circuitry omits execution of the rule verification for transaction information identified by the stored verified transaction identification information.

7. The information processing system according to claim 1, wherein the verification processor circuitry executes the token transfer verification by executing record verification that verifies that transaction information that is included in the transaction history information and represents a transfer immediately prior to the transfer represented by the new transaction information is recorded in the distributed ledger.

8. The information processing system according to claim 1, wherein, when the token transfer verification for the new transaction information and the transaction history information succeeds, the second node device stores verified transaction history identification information identifying the transaction history information that includes the group of transaction information pieces corresponding to the history of transfers of the token from issuance of the token to the transfer represented by the new transaction information, the transaction history information including the group of transaction information pieces in association with the order of transfers in the history, and
wherein the verification processor circuitry omits, among token transfer verification for the received new transaction information and the received transaction history information, execution of a portion corresponding to a portion of the transaction history information identified by the stored verified transaction history identification information.

9. The information processing system according to claim 8, wherein the transaction information includes transfer-history hash value information generated by inputting, to a hash function, transaction history information including a group of transaction information pieces corresponding to a history of transfers of the token from issuance of the token to a transfer immediately prior to a transfer represented by the transaction information, the transaction history information including the group of transaction information pieces in association with an order of transfers in the history,
wherein the verified transaction history identification information storage uses, as the verified transaction history identification information identifying the transaction history information, transfer-history hash value information generated by inputting the transaction history information to the hash function, and
wherein the verification processor circuitry omits, among the token transfer verification for the received new transaction information and the received transaction history information, execution of a portion corresponding to a portion of the history of transfers of the token from issuance of the token to a transfer immediately prior to a transfer represented by transaction information including transfer-history hash value information matching the stored verified transaction history identification information.

10. The information processing system according to claim 1, wherein the second node device comprises a second transmitter configured to, when the token transfer verification succeeds, transmit the new transaction information by broadcast and, when the token transfer verification fails, not transmit the new transaction information.

11. An information processing method for recording, in a distributed ledger constituted by a blockchain, transaction information representing transfer of a token associated with a coin between two wallets among a plurality of wallets, wherein a plurality of node devices each including at least one of the plurality of wallets communicate according to a peer-to-peer scheme, the information processing method comprising:
generating, by a first node device including a first wallet, new transaction information that is transaction information representing transfer of the token from the first wallet to a second wallet;
transmitting, by the first node device to a second node device including the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history;
receiving, by the second node device, the new transaction information and the transaction history information; and
executing, by the second node device, token transfer verification, based on the received new transaction information and the received transaction history information, to verify that the transfer of the token to the second wallet is a valid transfer of the token issued by a true issuer.

12. A first node device in an information processing system for recording, in a distributed ledger constituted by a blockchain, transaction information representing transfer of a token associated with a coin between two wallets among a plurality of wallets, wherein a plurality of node devices each including at least one of the plurality of wallets communicate according to a peer-to-peer scheme, the first node device including a first wallet, the first node device comprising:
a generator configured to generate new transaction information that is transaction information representing transfer of the token from the first wallet to a second wallet; and
a transmitter configured to transmit, to a second node device including the second wallet, the generated new transaction information and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history.

13. A second node device in an information processing system for recording, in a distributed ledger constituted by a blockchain, transaction information representing transfer of a token associated with a coin between two wallets among a plurality of wallets, wherein a plurality of node devices each including at least one of the plurality of wallets communicate according to a peer-to-peer scheme, the second node device including a second wallet, the second node device comprising:
a receiver configured to receive new transaction information that is transaction information representing transfer of the token from a first wallet to the second wallet, and transaction history information including a group of transaction information pieces corresponding to a history of transfers of the token from issuance of the token to a transfer immediately prior to the transfer represented by the new transaction information, the transaction history information including the group of transaction information pieces in association with an order of transfers in the history; andverification processor circuitry configured to execute token transfer verification, based on the received new transaction information and the received transaction history information, to verify that the transfer of the token to the second wallet is a valid transfer of the token issued by a true issuer.
